(19) United States
(12) Patent Application Publication
(10) Pub. No.: US 2008/0005290 A1
(43) Pub. Date: Jan. 3, 2008

(54) Terminal reachability

(75) Inventors: Petri Nykanen, Nokia (FI); Jari A. Mononen, Ruutana (FI); Patrik Gustafsson, Espoo (FI); Seppo Pohja, Tampere (FI); Ulla Konkarikoski, Tampere (FI); Jyrki Valli, Tampere (FI); Jose Costa-Requena, Helsinki (FI); Igor Curcio, Tampere (FI); Juha Hietasarka, Suinula (FI); Holger Hussmann, Tampere (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/708,576

(22) Filed: Feb. 21, 2007

(30) Foreign Application Priority Data
May 19, 2006 (EP) 06114280.8

(51) Int. Cl. G06F 15/177; G06F 15/173

(52) U.S. Cl. 709/222; 709/249

(57) ABSTRACT

A communication network for providing seamless peer-to-peer connectivity between nodes of different communication network environments, the communication network comprising at least one tunneling server comprising an access unit for providing access to the communication network and an addressing unit for assigning a dynamic address of a first addressing scheme routable in the communication network to a node connecting itself to the tunneling server, the node having a fixed address of a second addressing scheme, and storing at runtime an association between the fixed address of the second addressing scheme and the dynamic address of the first addressing scheme.

### BACKGROUND OF THE INVENTION

1. Field of the Invention

The present invention relates to a communication network for providing seamless peer-to-peer connectivity between nodes of different communication network environments.

2. Description of the Related Art

Several client-server solutions exist where services are implemented in network server and terminals can connect to the servers getting the provided services. In such cases the value is accumulating to the server that implement the business logic, see FIG. 1, highlighted case (1). However, client-server solutions where service is implemented in mobile terminal are not possible today, as no general solution exists (highlighted case 2a). Also, use cases to contact remotely services at home are possible only in limited cases/specific configurations. Similarly there is no general solution (highlighted case 2b). In most cases the connection can only be initiated from terminal towards the public network, but not the other way around. So, the direct connection between clients in access networks is not possible, because there is usually one or more network address translations (NATs) or network address and port translations (NAPTs) that prevent the connection from public network towards the terminals and the inbound connection is blocked.

If nodes are not addressable and reachable regardless of the underlying network infrastructure, products where new applications and services are implemented in the nodes (e.g. mobile phones) will be dependent on state and configuration of each of the networks where the nodes are connected. In other words, it is not possible to implement fast new mobile applications and services, if these services depend on certain infrastructure and specific configuration to be present in each of the operators networks. Therefore, addressing and reachability is an issue.

### SUMMARY OF THE INVENTION

The invention should make terminals, regardless of the access network, addressable and reachable by other terminals. The invention is not limited to mobile phones, it can be widely utilized in many types of terminals. The access networks can range from cellular packet data to fixed Ethernet cabling.

Addressability means the capability to map a hostname to a currently valid IP address of the terminal. If Party A that wants to communicate with Party B knows the hostname of party B, according to the invention it is possible for Party A to find out the current IP (IPv6 (Internet Protocol version 6)) address of Party B.

An architecture according to the invention is described which provides seamless peer-to-peer connectivity between devices in different environments. The invention covers three issues related to connectivity between clients (mobile phones, PCs, home appliances) regardless of the underlying network infrastructure:

Provide addressing capability of individual clients (hostname mapping to corresponding IPv6 address);

Provide reachability of IPv4 and IPv6 packets between clients (solving NAT (Network Address Translation)/NAPT (Network Address Port Translation), FireWall traversal and tunneling requirements when needed); and

Provide filtering of unwanted incoming traffic for clients where incoming communication is charged. The invention presents an enabling technology for several applications and services. The architecture and infrastructure components of the invention need to be highly scalable, and local routing optimizations need to be utilized when possible. The invention provides means and services for Client-to-Client (P2P) communication as follows:

Registration capability for new terminal to take part in the service and to become part of the connectivity network.

Addressing capability of clients based on IPv6 enabled dynamic domain name service.

Reachability, i.e. packet routing between clients logged in to the network.

Filtering of unwanted packets based on verifying voucher received from the connecting client. The vouchers have been exchanged between clients prior to connection.

Security provided only on a level required for filtering out unwanted incoming traffic. For application level security, end-to-end security schemes based on SSL (Secure Socket Layer), IPSec (Internet Protocol Security) need to be utilized separately from connectivity, on top of it. A firewall for handling incoming traffic to client will be needed on the terminals in any case. Secure connections need to take place end-to-end as parties should not trust hop-by-hop security model.

Client-to-client communication can take place in a network where there are (untrusted) nodes. The trust relationships of the client are: Client to the proxy provider chosen, and client-to-client based on the Firewall access vouchers.

Required connectivity system functionalities:

Generation and exchange of firewall access vouchers by clients (used to identify clients allowed to initiate contact)

Sending of firewall access voucher by client to firewall authorization server prior to contacting the client, and capability to validate the vouchers by authorization server.

Potentially hiding from applications in clients both generation and exchange, and the (out-of-band) sending of firewall access vouchers.

According to a first aspect, the present invention combines tunneling, dynamic DNS (Domain Name Server) service, and IPv6 to make mobile terminals addressable and reachable nodes, by other nodes registered to same network.

Another aspect of the invention relates to how firewall(s) and tickets/shared secret exchanged between nodes (parties A and B) can be used to weed out unwanted incoming traffic before it causes costs to the receiving party, especially in case of cellular packet network where the receiving party pays for incoming traffic. This aspect may be utilized in the same system as the first aspect.

### BRIEF DESCRIPTION OF THE DRAWINGS

FIG. 1 shows a general connectivity state according to the prior art.

FIG. 2 shows a connectivity state according to the invention.

FIG. 3 shows a schematic diagram illustrating the nodes and main protocol interfaces (Client1, Overlay Proxy Server, Overlay DNS Server) according to an embodiment of the invention.

FIG. 4 shows a chart illustrating pre-connection procedures (all) according to an embodiment of the invention.

FIG. 5 shows a chart illustrating procedures when connected (excluding “authorize incoming traffic (certificate)”) according to an embodiment of the invention.

FIG. 6 shows a schematic diagram illustrating different tunneling and client types according to an embodiment of the invention.

FIG. 7 shows a schematic diagram illustrating connection through a public Ipv6 tunnel server according to an embodiment of the invention.

FIG. 8 shows a schematic diagram illustrating an outbound only connection through tunnel server according to an embodiment of the invention.

FIG. 9 shows a signaling diagram illustrating a connection to a proxy server attached with configurable firewall according to an embodiment of the invention.

FIG. 10 shows a schematic diagram illustrating a connection to a tunneling proxy server according to an embodiment of the invention.

FIG. 11 shows a signaling diagram illustrating a firewall configuration in proxy server according to an embodiment of the invention.

FIG. 12 shows a schematic diagram illustrating a connection to proxy server and updating DNS entry according to an embodiment of the invention (the firewall and firewall authorization server are not relevant for this embodiment).

FIG. 13 shows a signaling diagram illustrating a registration sequence according to an embodiment of the invention.

FIG. 14 shows a schematic diagram illustrating a node architecture according to an embodiment of the invention.

FIG. 15 shows an originating party example in the node architecture of FIG. 14.

FIG. 16 shows a receiving party example in the node architecture of FIG. 14.

FIG. 17 shows a signaling diagram illustrating a CL-CL Service Capability Query protocol example.

FIG. 18 shows a schematic diagram illustrating a connection of another client to a client behind a firewall according to an embodiment of the invention.

FIG. 19 shows a schematic diagram illustrating the connection of the other client to the client behind the firewall of FIG. 18 in greater detail.

FIG. 20 shows a schematic block diagram illustrating components of the connectivity network system according to the present invention.

### DESCRIPTION OF THE PREFERRED EMBODIMENTS

The present invention combines technologies for tunneling, dynamic DNS, and IP networking in a way that enables addressing and reachability for nodes (mobile phones, PCs, home set top boxes, etc.) that would not be otherwise addressable or reachable.

Address Space

The number of Internet IPv4 addresses is limited. To overcome the scarcity of Internet addresses NATs and NAPTs have been used. Nodes behind NATs or NAPTs do not (necessarily) have address that is routable from Internet. Typically such nodes become addressable once they initiate connection towards Internet. Depending on the type of NAT/NAPT the node may and, more importantly, may NOT even then be addressable by other nodes in the Internet.

If a large number of new nodes (like mobile terminals) are brought to Internet, the number of IP addresses needed for the terminals will be an issue. Even though NAPT approaches (which can share one IP address with more than 65 k nodes) do help in making the address space larger, they complicate reachability of the nodes further.

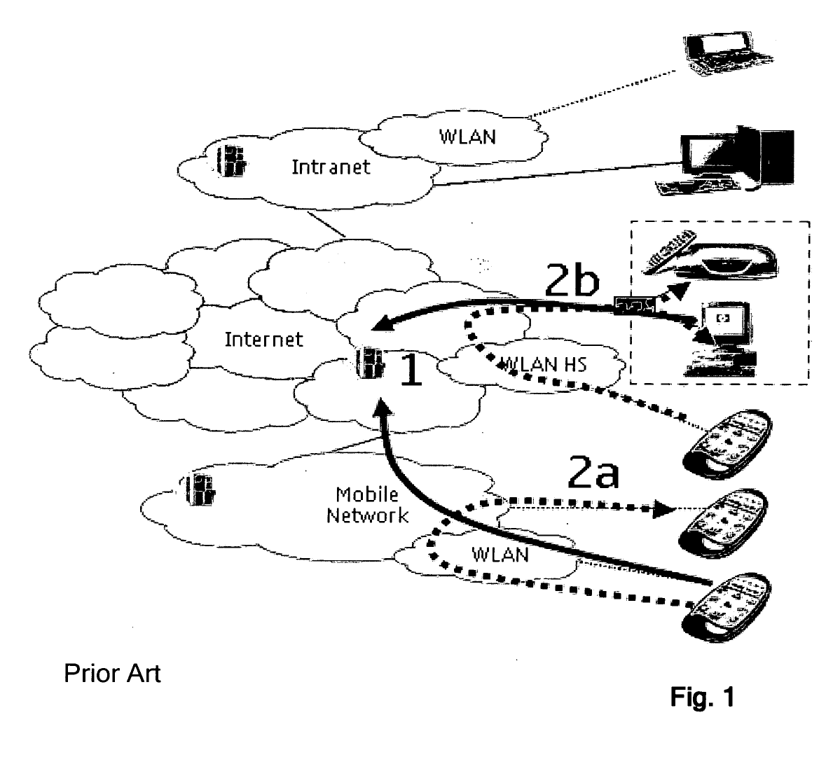

According to the present invention the nodes will become addressable in an overlay network to be described in the following referring to FIGS. 1-8. As the expected number of nodes is high the same addressing problems as with Internet would apply to the overlay network where the nodes are registered. In embodiments of the invention, the nodes have IPv6 address in the overlay network thus avoiding the limitations of the IPv4 address space.

Addressability

Internet nodes that are behind NATs or NAPTs and/or firewalls typically have grey IP address that is usually dynamically allocated (through DHCP (Dynamic Host Configuration Protocol)). The grey IP address is not routable in the Internet, and it would not make sense to map a hostname to such IP address. Usually such nodes are only able to initiate connections as Party A (originating party) to Internet nodes (located on the other side of the NAT/NAPT/Firewall).

In specific configurations dynamic DNS server in Internet can be utilized to first determine the currently valid IP address of the node (as it is visible in the Internet), and then to associate this IP address to hostname. The dynamic DNS server will then serve this information in the Internet Name server network. Depending on the network configuration between the node and the Internet (especially NAT/NAPT/Firewall) just by making the association (hostname, IP address) is not enough for truly communicating with the node from Internet.

The combination of dynamic DNS with the tunneling approach enables the terminal to have IP address that stays valid, and it handles NAT, NAPT and firewall traversal issues.

Reachability

As with addressability, Internet nodes that are behind NATs or NAPTs and/or firewalls typically have grey IP address that is usually dynamically allocated (through DHCP). The grey IP address is not routable in the Internet, and it would not make sense to map a hostname to such IP address. Usually such nodes are only able to initiate connections as Party A (originating party) to Internet nodes (located on the other side of the NAT/NAPT/Firewall).

It is possible to utilize known tunneling technologies (like IPSec, PPTP (Point-to-Point Tunnelling Protocol), Teredo) that tunnel all communication in and out of the node through a tunneling server (or all the way end-to-end). When initiating tunneling connection from node (e.g. mobile terminal) towards Internet, the NAT/NAPT/Firewall traversal problems can be mitigated. The networks where the nodes like mobile terminals are, usually allow communication towards Internet to be initiated, but they block communication from Internet towards the nodes in these networks (due to security or charging issues).

Furthermore, the tunneling protocols may contain functions such as heartbeat that will keep alive the connection from the node to the tunneling server in the Internet. They may also contain functions to identify if communication can be initiated directly between two nodes, bypassing need for tunneling server supported communication between those nodes.

In embodiments of the invention the tunneling protocols are used to connect all nodes to an overlay network where each terminal is assigned an IP address that is reachable in that network by other nodes of the same network. The overlay network is another network set up on top of multiple networks (i.e., the Internet).

Utilizing any one or two of IPv6 addresses for mobile terminals, providing (dynamic) DNS entries, or implementing tunneling may not solve addressing and reachability problem of mobile terminals (or home PCs or set top boxes).

It has been found that the combination of the three in the following manner can solve the stated problems in a way that is independent of the network configuration of the network the node is currently in:
An overlay network is defined. This overlay network is a network built on top of the current IPv4 network, and it is IPv6 based.
Nodes that are behind NAT/NAPT/Firewalls initiate themselves connection to tunneling server that provides access to the IPv6 overlay network. Multiple tunneling technologies can be utilized and some tunneling servers may support only one or all of the tunneling technologies utilized. Heartbeat function for created tunnel might be used to keep the tunnel open, when required.
Tunneling server assigns the node an IPv6 address that is routable in the overlay network. The tunneling server stores at runtime the association between the nodes “real address”, i.e., the IPv4 Internet address and the current IPv6 address. Thus it is capable of routing packets with IPv6 address through tunnel to the corresponding node.
Nodes update their (or alternatively the tunneling server does this on their behalf) overlay network address to dynamic IPv6 DNS server available to other nodes in the overlay network.

The result is that all nodes connected to the overlay network can request with hostname the current IPv6 address of another node connected to the overlay network. The (hostname, IPv6 address) pair is kept valid as the information is updated to the dynamic DNS server always the IPv6 address changes.

Because the IPv6 address of the node is assigned by the tunneling server (one function of “Proxy server” described below), the IPv6 packets in the overlay network will be routed to this tunneling server based on known Internet technologies. Furthermore, as the tunneling server knows the IPv4 addresses from each of the nodes connected to it, it can route the IPv6 packets correctly to the tunneling clients it has.

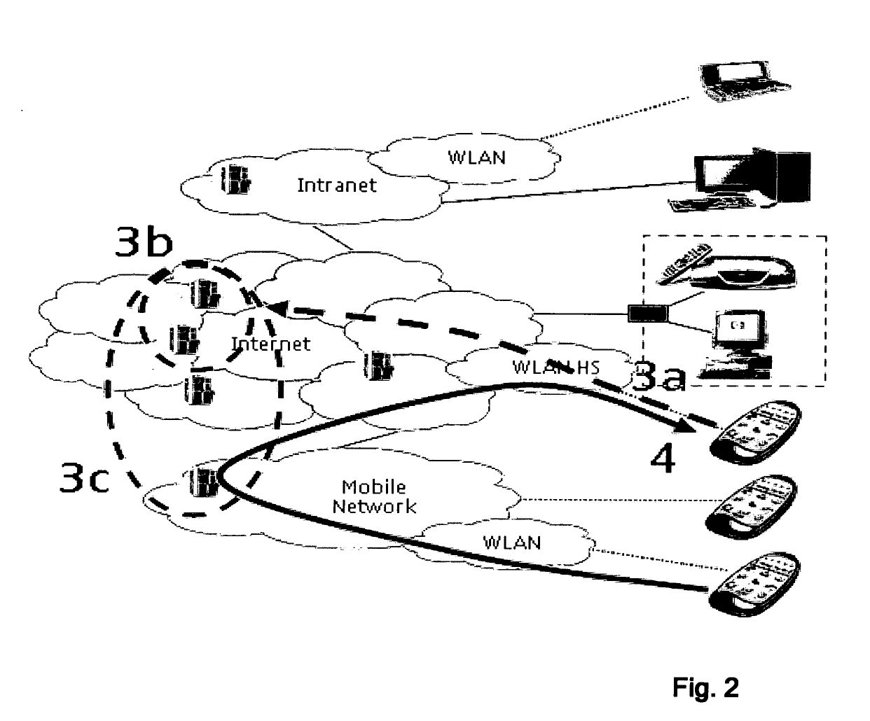

To solve the addressing and reachability of the mobile terminals (and home appliances) as shown in FIG. 2, in Internet a stack of the mobile terminal capability to tunnel communication through an overlay network is implemented, and this capability is provided to applications (highlighted in FIG. 2 as 3a). An overlay network is created in Internet where terminal registers (highlighted as 3b). (Various) operators are enabled to take part into operating the overlay network (highlighted as 3c). First applications are created to utilize the solution (highlighted as 4) and that accumulate value to the terminal, (e.g., implementing web server to terminals, with sufficient access control to limit cost implications).

An overlay network is a virtual network built over one or more physical networks. The Internet is itself an example of an overlay network. In overlay networks the individual links that connect nodes can comprise multiple routers and hosts. The chosen architectural approach is based on overlay proxy servers where the clients of the overlay network register to get addressing, reachability and packet filtering services. The packet routing, which is based on known Internet technologies, takes place between the proxy servers. Enhancements to proxy based overlay architecture enable clients to communicate directly with each other in specific cases (i.e., packets routable directly between clients).

Intuitively proxy based overlay architecture is not the best optimized way of making a connection between two network nodes, however

Reachability cannot be ensured in many cased unless proxies are utilized.

Costs implications of incoming traffic cannot be limited unless a network entity exists that filters incoming packets. Functional requirements lead to selection of proxy based architecture. However, the role of the proxy and its potential for control point (controlled by third parties) is minimized. This may mean that

Proxy is used only for implementing addressing and reachability.

Strong authentication of peers is achieved using client-to-client access vouchers (if needed) to ensure that clients and network entities are what they claim to be.

Adequate packet filtering needs to be implemented to avoid unsolicited traffic towards end-users.

Device addressing is based on standard Internet technology (hostname.domainname mapping to IP address) avoiding use of proprietary server side identities/buddy lists. Applications can rely on standard Internet technologies for terminal addressing.

Architecture needs to support enhancements where peer-to-peer connectivity can take place without proxy involvement (when network configuration enables that).

Terminal capabilities are stored and queried from terminals, not building centralized databases to network infrastructure.

From terminal application point of view proxy architecture is transparent, (i.e., no dependencies in applications to proxy functionality).

Terminals store the mutually exchanged firewall authentication vouchers and provide certificates to authentication server for packet filtering purposes.

End-user can do black listing of already given access rights, providing revocation list (identifiers of non validated tickets) to firewall managing server.

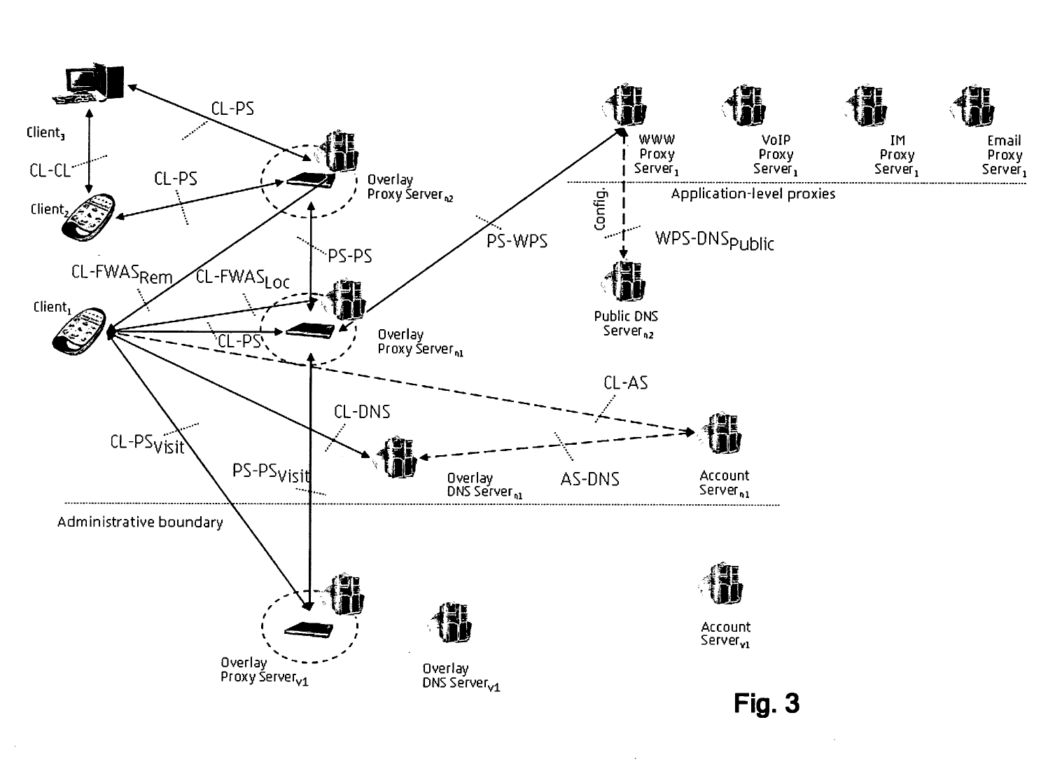

In the following, the nodes, or entities, of the overlay proxy architecture are described, and the key end-to-end protocol interfaces in the architecture (between the nodes) are outlined, referring to FIG. 3. This embodiment concentrates on the highlighted interface (CL-PS), between an overlay network client (client1) and functionality of the overlay network proxy server (Overlay Proxy Serverh1).

The overlay proxy architecture in embodiments of the invention may comprise nodes as explained in the following. It shall be appreciated that the naming of the nodes is only given for illustrating and simplifying the description of the invention. Some of the nodes may also be omitted in case the functionalities are taken care of another node. In some embodiments, there may be more nodes in the overlay architecture carrying out described functionalities.

In an embodiment, the nodes of the overlay architecture may comprise:

Client—a device, mobile or fixed/tethered, having functionality to login to and use the overlay network. In FIG. 3 clients 1, 2, and 3 are depicted.

Overlay Proxy Server—a server entity capable of providing clients access to the overlay network. In FIG. 3 two proxy servers, h1 and h2 are identical and operated by the same business entity, while the third proxy server (Overlay Proxy Serverv1) represents a federated proxy server operated by some separate business entity (such as mobile operator, ISP or public community IPv6 network). Thus an administrative boundary exists between the proxy server h1, h2 and v1. Proxy server has two main functions; it handles the basic data plane IPv6 traffic routing between connected clients and between different proxy servers, making this as efficiently as possible. It also has logical control plane functionality, being a local cache for storing the credentials to enforce access control for connected mobile devices. In practice, the required functionalities of traffic tunneling between tunneling server and client, inbound firewall for traffic blocking and access control server to configure the firewall rules have been separated, but is logical to handle it as a complete functionality and call it as “overlay proxy server”.

Overlay DNS Server—a name server capable of providing standard (dynamic/noncacheable) name server functionality. The overlay name servers provide DNS services within the overlay network (Overlay DNS serverh1) for domain administered by the entity. Overlay DNS server usually requires some level of authentication from clients updating the hostname entries with new IPv6 addresses. As additional security, optionally overlay DNS server may require authentication from clients accessing DNS data as well.

Account Server—a server capable of creating credentials and hostname identity for the client accessing overlay network for the first time. This service is optional in case that all required and static information has already been provided to the client using other means (e.g., user input for advanced network settings, configuration settings made by specific service provider etc.). However, Account Server makes the delivery of addresses of available tunneling servers, corresponding tunneling protocols and possible access rights for proxy servers easier to manage.

Public DNS Server—a name server capable of providing standard (cacheable) name server functionality (Public DNS serverh2). The public name server provides DNS services outside the overlay network as part of the global DNS cloud of name servers in the Internet. The main purpose of the highlighted public DNS server is to provide hostname.domainname mapping in public Internet from the client's name to the address of the WWW (World Wide Web)/VoIP (Voice over IP)/IM (Instant Messaging)/Email proxy server. The proxy server acts as a front-end for any connection attempts from Internet (entities that are not logged in as clients in the overlay network) to the client. It depends on the application-level protocol whether such DNS mapping is sufficient.

The naming scheme utilized by the application proxy servers should preferably be close to the naming scheme utilized within the overlay network. The hostname.domainname addressing cannot always be hidden from consumers (e.g., in URLs) and thus the logical approach is to have identical name for the client within and outside of the overlay network. This would mean that the Overlay DNS server and the Public DNS server in home network are both controlled by the same administrative party. However, the approach does not limit any other party from setting up application level proxies and utilizing address rewrites or other technology.

The updates to the Public DNS server are not frequent. Assuming that there is an application level proxy handling clients in foobar.arena.net, the DNS server would have only initial update of DNS entry for *.foobar.arena.net, pointing to the address of the application level proxy. This would provide the address of the correct proxy server to all requests for any (client) address ending with .foobar.arena.net.

If there are multiple application level proxies, they may need a front-end system that receives all connections and protocols, and will redirect the request to the correct application level proxy, based on port/protocol information.

FIG. 3 does not highlight the fact that all overlay network entities such as tunneling servers and DNS servers also have their carrier network IPv4 addresses. Such IPv4 addresses usually have also corresponding hostname entries in public DNS. DNS entries for proxy servers are relevant, because a client may have either the IP address or the hostname of the proxy in its initial configuration. Having a hostname for proxy server in client's configuration data provides possibility to “move” the overlay network to new address space without need to change the terminal configuration data, because the hostname is mapped to IPv4 address at runtime.

The various protocol interfaces between nodes of the overlay architecture are divided to three groups: home network protocol interfaces, visited network protocol interfaces, and application-level protocol interfaces. The home network protocol interfaces describe the key protocols related to base functionality of an overlay network. The visited network protocol interfaces describe what protocol interactions are needed for communicating with nodes in a federated, separately administered, network. The application-level protocol interfaces are related to interfacing with application-level proxy servers.

Protocol interfaces relevant for clients in home overlay network (administrative area selected or commonly used by end-user) comprise the following:

CL-PS—Interface between an overlay network client and a proxy server in home overlay network. This interface may implement:

Client initiated selection of proxy server to connect.

Client initiated login to selected proxy server (when required).

Proxy server initiated redirection of client to connect another proxy server (maintenance, load balancing, federation cases). The redirection is also initiated in cases when proxy does not accept connection from client.

Client initiated update of certificate or revocation list for this client (update of the client's certificate and blacklist data at the firewall managing server).

Client initiated setup of a tunneling connection based on supported tunnel protocols and network connection configuration of client.

Proxy to provide client an IPv6 address or IPv6 subnet.

Client initiated or proxy server initiated closing of tunneling connection.

Client/server initiated heartbeat function to maintain transport (especially in cellular networks, e.g., maintaining IP connection in 2.5 G networks) and also for maintaining NAT address and port binding.

CL-CL—Interface between an overlay network client to another client in the same network. This interface may divide to five groups of interfaces:

(i) Client-to-client local routing enhancements,

(ii) Client-to-client access policies with finer granularity (or when not supported or cached in proxy server),

(iii) Client-to-client hosting to provide address from local subnet received from proxy server to another sub-client directly connected to terminal,

(iv) Client-to-client service capability queries, and

(v) Client-to-client application protocols, such as smart synchronization of contact information.

Only the first three groups of interfaces are directly related to overlay network functionality. The other two can be viewed as peer-to-peer application level protocols on top of the addressing and reachability provided by the overlay network.

Also in case ii) client policies have multiple levels, where application level negotiation is usually required to configure local firewall to enable connection to specific service. Following requirements correspond to these interfaces:

i) Client-to-client Local Routing Enhancements:

Client-to-client authentication challenge (voucher request, response).

Authentication based on given ticket and certificate.

ii) Client-to-client Access Policies:

Terminal cached client-to-client access permission (request, response).

Finer granularity enabled with shared and stored mCard content.

iii) Client-to-client Hosting:

Terminal serving sub-client (network parameters and protocols).

Sub-client cannot exceed identity or permissions set for actual client.

Sub-client hostname is served as higher-level domain of client, requiring that client can handle local sub-client domain name services.

iv) Client-to-client Service Capability Queries:

Capability query (protocol).

Stored to xCard content database, probably shared with local web server.

v) Client-to-client Local Application Protocols:

Smart contact synchronization (protocol).

CL-DNS—Interface between a client to domain name server. This interface may implement:

DNS to provide current IPv6 address of hostname.domainname entry of an overlay network client within the overlay network. When applicable, can be implemented requiring authentication and authorization of client, requesting services of domain name server (i.e., SecureDNS option).

Authentication of client requesting DNS update services of domain name server. Request DNS to update user defined or selected (secondary) non-cacheable hostname.domainname entry of an overlay network client within the overlay network. Also support for updates of additional pre-defined hostnames (firewall managing server, IMEI-hostname for service requests etc).

PS-PS—Interface between a proxy server to another proxy server in home overlay network. This interface may implement:

Authentication of the other proxy servers (when required).

Packet routing of the IPv6 overlay network traffic.

Exchanging information of valid proxy servers in network. The common functionalities for both PS-PS and CL-PS are likely to be tunneling alternatives (when not having public IPv4 addresses), and heartbeat functionality.

CL-AS—Interface between an overlay network client and an account creation server. Account server needs to be capable of providing access information to overlay network and providing hostnames in administrated domain space to allocate required hostname(s) for the client. This interface may implement:

Handle client initiated first-time registration (identity creation and administration)

Identity authentication

Creation of valid client (username, password) for DNS update.

Checking if requested hostname is available.

Delivery of valid and updated proxy tunneling server list to client.

Optionally delivery of valid connectivity policies (credentials) to access proxy servers in proxy list, with expiration time, if required.

CL-FWASLoc—Interface between an overlay network client and a local firewall access server.

Handle the identity authentication of incoming network client.

Handle the exchange of client provided self-certificate to firewall managing server.

Handle the exchange of client provided black list (revocation of given access vouchers).

CL-FWASRem—Interface between an overlay network client and a remote firewall access server.

Handle the identity authentication of network client requesting access to another terminal behind the firewall. This needs to be done using additional challenge-response pair.

Validation of access voucher provided by client requesting access to client behind firewall. This will be done using self-certificate given by client behind firewall.

Enforcing black list (revocation of given access vouchers) given by client behind firewall.

Functionalities to be supported by the protocol interface primitives of the CL-PS (Client-Proxy Server) interface as shown in FIG. 3 may comprise:

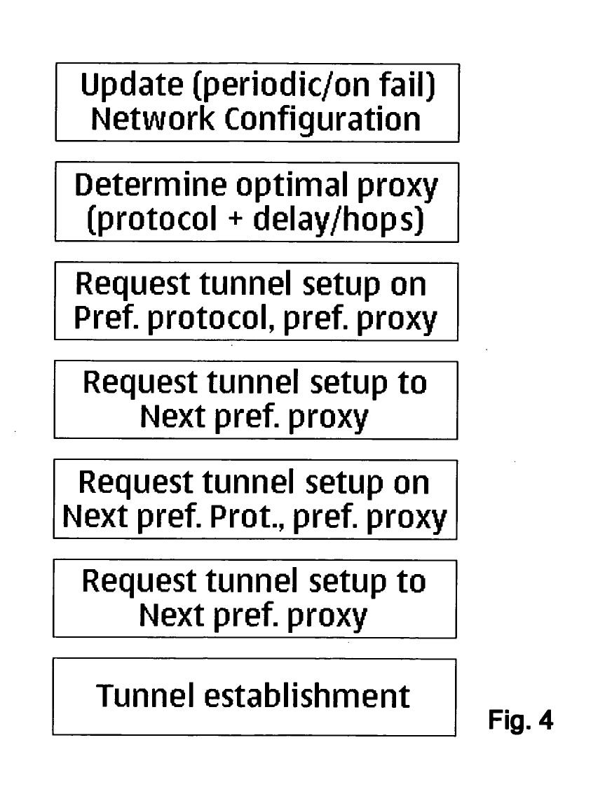

Connecting—Proxy selection, tunneling and heartbeat functionality (see FIG. 4, to be described later on); and

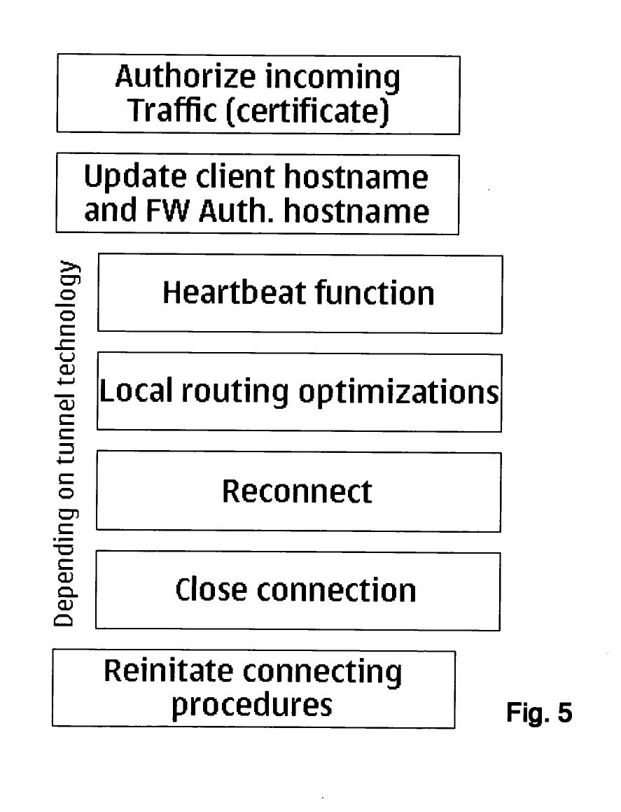

Connected—Authorization and policy setting functionality (see FIG. 5, to be described later on).

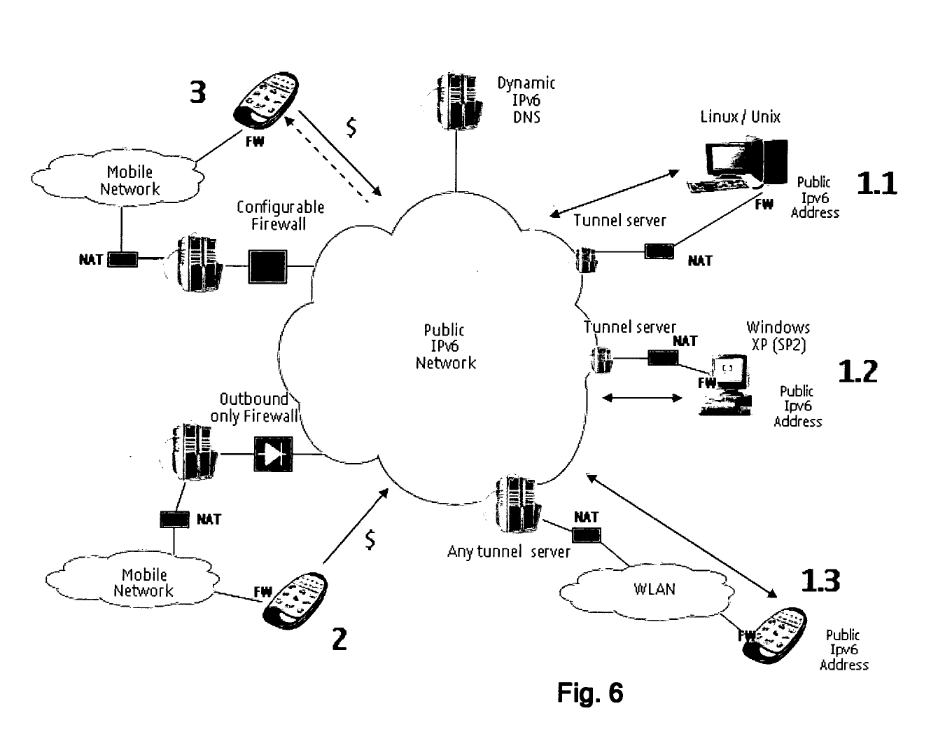

The basic principle when connecting to the IPv6 network is to get routable IPv6 addresses for clients and enabling that traffic can transparently pass through the network. However, usually a device will get first a standard IPv4 address. Later on, on top of the IPv4 connection (using either tunneling mechanisms or some of the 6-to-4 traversal techniques) the device will get routable (temporal) IPv6 address. Establishing the tunneling connection to IPv6 network can be made with several ways. In FIG. 6 some differences are highlighted.

Connection Through Public Tunneling Servers (Case 1)

Case 1 (with three sub cases) illustrated in FIG. 6 describes the basic method to be part in public IPv6 Internet.

For example, Linux/Unix based machines can use 6to4 protocol to get public IPv6 addresses routed on top of IPv4, when having interface for public IPv4 address. If the workstation is behind firewall of NAPT, other tunneling technologies need to be used, like IPsec or PPPoE. The example 1.1 in FIG. 6 shows a case where the workstation is behind cone NAT (gray box), so one possible technology is to use Miredo (Open source version of Teredo protocol). Using that protocol packet routing is mainly done using public NAT IPv4 address and UDP port pairs, but still the workstation gets (possible temporal) routable public IPv6 address.

Another example 1.2 in FIG. 6 shows similar situation in case that another PC has been connected to public IPv4 Internet through cone or restricted NAT. All Windows XP installations (with SP2) have the capability to open Teredo tunnel and establish connection to public routable IPv6 network. There is full analogy with case 1.1. It is also possible to create Virtual Private or Public Network (VPN) using other tunneling technologies available in Windows, and enable connectivity to Public IPv6 network. However, when Teredo can be used, it consumes fewer resources in other tunneling end, compared to point-to-point type of tunnels.

The case 1.3 illustrates that same technologies can also be used in mobile devices. However, when connection has been made using any of the tunneling methods and IPv6 routing has been established, there are no preventing mechanisms available to block any incoming traffic towards the mobile device. In case that device is using costless or flat fee type of connection, this is hardly a problem, but if there is cost implication, usually some kind of blocking of incoming traffic is needed. In any case, local firewall is needed in mobile device to block unwanted connection attempts to the terminal.

Common to all these cases is that when the connection to IPv6 network has been established, the client connected to network needs to update the information of current IPv6 address to Dynamic Domain Name Server (shown in top of FIG. 6). Doing that any of the other clients can make the query to the name server and receive current address of other peer, making it possible to route packets to that direction.

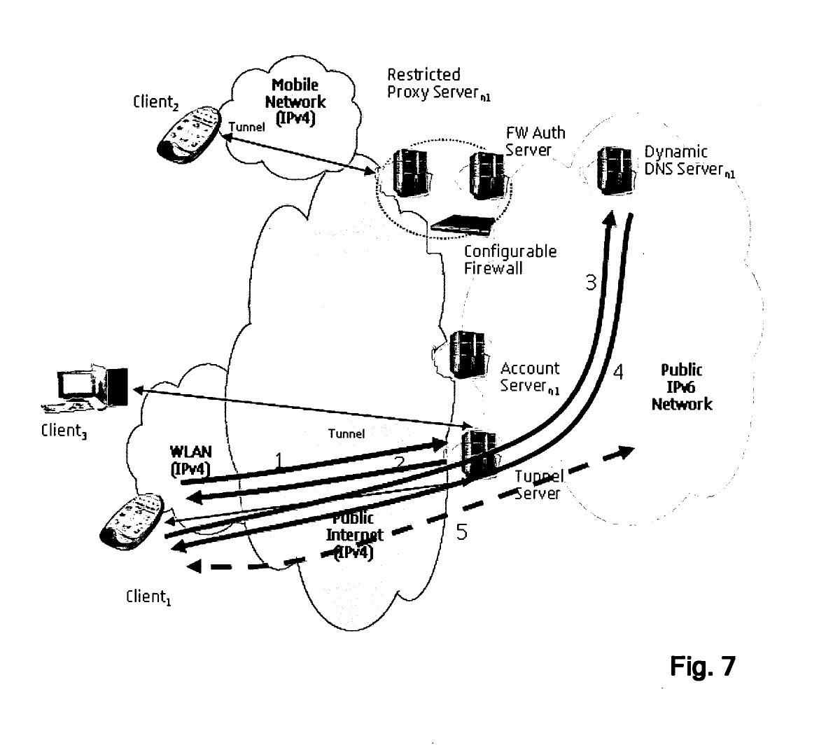

The steps of creating connection to overlay network and gaining addressability and reachability for client are illustrated in FIG. 7. In practice, same steps are carried out in all to the sub cases 1.1, 1.2 and 1.3, described above and illustrated in FIG. 6. In this case all traffic is passed towards client and the place where unwanted traffic is blocked happens in local firewall of the client.

Reference is made to FIG. 7:

1. Client1 uses the Tunnel Server 2 address configured to the advanced settings. Client1 initiates connection to Tunneling Server to establish tunnel.

2. Tunnel connection is created and Client1 receives IPv6 address from address pool served by Tunnel Server 2.

3. Client 1 knows its own IPv6 address, and the IPv6 address of the FW authorization Server, Client 1 updates corresponding DNS entries to name server through the tunnel.

4. Dynamic DNS server confirms to Client1 that both entries have been updated to name space.

5. Traffic to Public IPv6 network is established.

This connection type does not prevent any incoming traffic to reach client, so in case that client uses cellular network to connect this kind of open tunneling server, there will be cost implication of all incoming traffic. However, there are some cases when this can be acceptable (no cost or flat free interfaces, WLAN). The tunneling server in this case is well scalable, when there is no need for checking credentials from incoming connections.

Connection Through Outbound Only Tunnel Server (Case 2)

When incoming traffic has cost implications to end-user, it is not enough that only local firewall weeds out unwanted packets. In such case, even when it may be against the basic philosophy of transparent IPv6 routing, another firewall or one directional NAT can be introduced. In FIG. 6 case 2 illustrates such situation. The gray box between tunneling server and public IPv6 makes it possible to pass traffic only originated from terminal and inbound traffic is only allowed from such parties where connection is first opened from mobile device. This makes it possible to access any services in IPv6 network just like being part of it like any other nodes, but prevents mobile device to provide any services to public IPv6 network. In cases that mobile device is not providing any services and it does not need to be reachable, this case is fine.

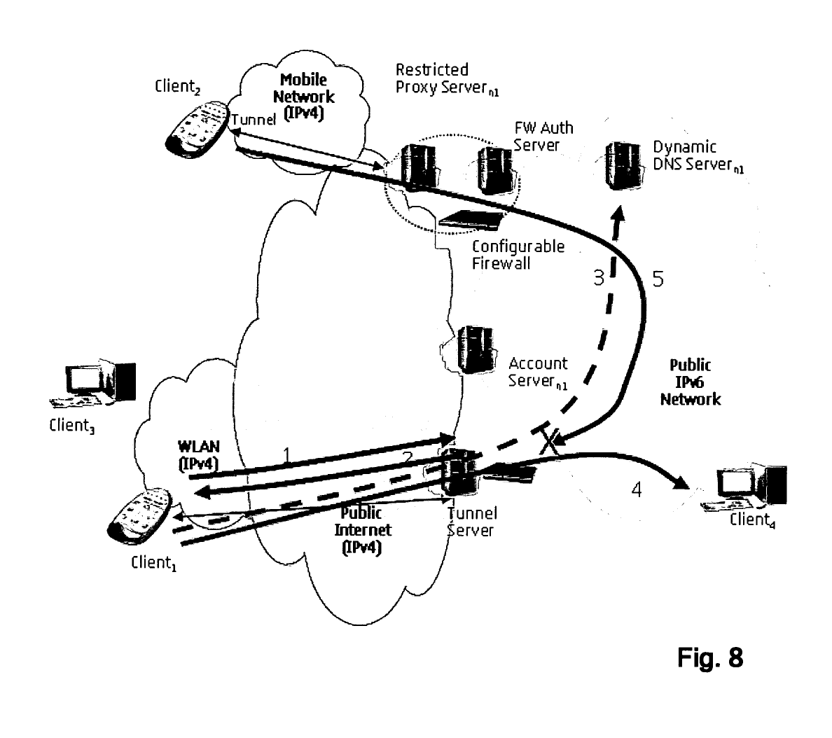

FIG. 8 illustrates the case where mobile device has connected the Public IPv6 Internet through outbound only tunnel server.

1. Client1 uses the Tunnel Server address (e.g., already manually configured as preferred server in the terminal settings). Client1 initiates connection to Tunneling Server to establish tunnel.

2. Tunnel connection is created and Client1 receives IPv6 address from address pool served by Tunnel Server.

3. Optionally Client 1 can update own IPv6 address entries to name server through the tunnel, but Client 1 will not be reachable through the firewall. In this embodiment, the firewall and the DNS server are separate entities.

4. Outbound traffic to Public IPv6 network is established and Client 1 can connect any of the nodes or services in IPv6 network, when initiating the connection.

5. However, none of the nodes in public IPv6 network can initiate connection and start to route packets towards Client1, because firewall blocks the incoming packets before those are passed to tunnel of Client 1.

Connection Through Proxy Service With Configurable Firewall (Case 3)

Client determines which proxy to connect in case 3 shown in FIG. 6. Not all proxies necessarily support the same tunneling protocols. Heuristics are implemented to client to select “cheapest” tunneling technology and work upwards until tunnel set up is successful. Proxies with configurable firewall will be used when there are cost implications of incoming traffic or end-user is entitled to premium service.

Proxy may comprise:

Tunneling Server

Tunneling server can initiate redirection of client to connect another proxy server (maintenance, load balancing, federation cases).

Firewall

Firewall handles drop/forward rules for 128 bit+128 bit address pairs (IPv6 addresses of originating and receiving nodes). Initially firewall does not allow any (incoming) traffic. It also handles the processing of session IDs of UDP packets, so that when connection is initiated towards another firewall, session ID is used to detect the allowed response from traffic coming from another firewall.

Firewall Authorization Server

Handles the authorization of incoming traffic using certificate provided by client connected to the proxy and tickets provided by clients requesting incoming connections. Firewall managing server handles also the challenges required to ensure that right entities are what they claim to be.

Connecting to the Tunneling Server

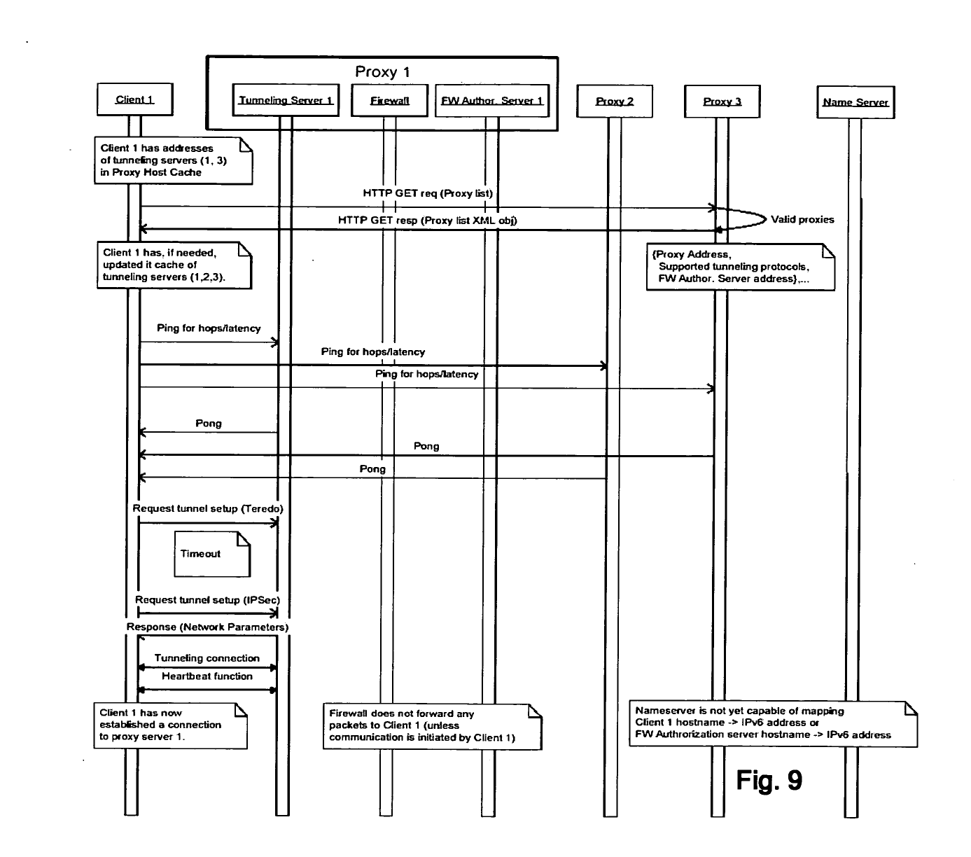

The sequence diagram used to communicate the first design choices for CL-PS protocol is shown in FIG. 9. The protocol interactions according to this embodiment take place between client 1 and Tunneling server. For this embodiment, the firewall and firewall authorization server are not relevant.

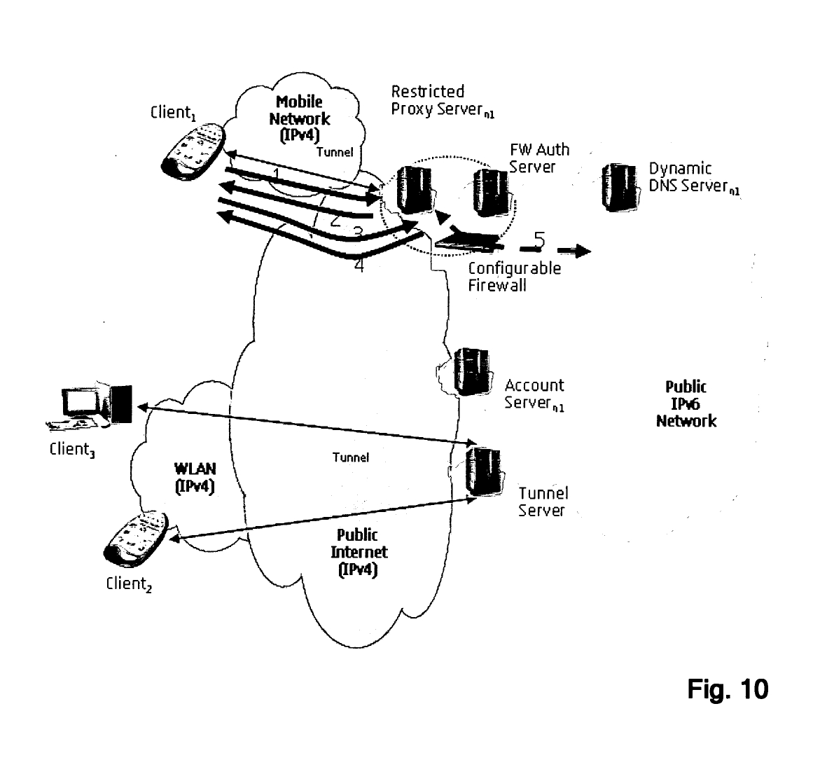

FIG. 10 illustrates how the connection steps described in the connecting sequence diagram shown in FIG. 9 are carried out (the firewall and firewall authorization server are not relevant for this embodiment):

1. Client1 may contact to any of the Tunneling Server it knows (initial list received from Account Server) and request updated list of available proxies.

2. Any of the Tunneling Servers (when capable and information available) can provide Client1 list of proxies. Proxy list can optionally be signed with right key (received initially from Account Server) if required.

3. Client1 can use heuristics to find the best serving proxy. Client1 initiates connection to Tunneling Server to establish tunnel.

4. Tunnel connection is created and Client1 receives IPv6 address from address pool served by Tunnel Server.

5. However, no traffic is yet routed through Configurable Firewall to Public IPv6 network.

Following requirements should be met:

Automatic selection of suitable tunneling protocol based on network configuration or used interface;

Heartbeat function client/server initiated to maintain transport (especially in cellular networks, e.g., maintaining PDP context in 2.5 G networks).

Using Proxy With Configurable Firewall

Referring again to FIG. 10, when client has managed to create an IPv6 tunnel to proxy server, next step is to configure routing of packets to the created interface. To initiate that, client 1 enables valid clients to connect to it by providing certificate to the firewall authorization server (FW Auth server). In addition, revocation list is given (validity vs. number of revocation items). When client 1 now knows its own IPv6 address, and the IPv6 address of the FW authorization server 1, it updates corresponding DNS entries to name server.

When another client 2 wants to establish connection with client 1, it already knows client 1 hostname and the hostname of the FW authorization server as these have been part of the certificate it has been given by Client 1. Client 2 can contact to Client 1 by first looking up the Client 1 hostname, and then looking up the FW authorization hostname given in certificate.

Client 2 contacts the authorization server the hostname entry points to, and is challenged by the server. If challenge is successful the FW authorization server makes (source, destination address) hole in the firewall. Scalability needs of tunneling server, FW, and the FW authorization server are typically different from each other.

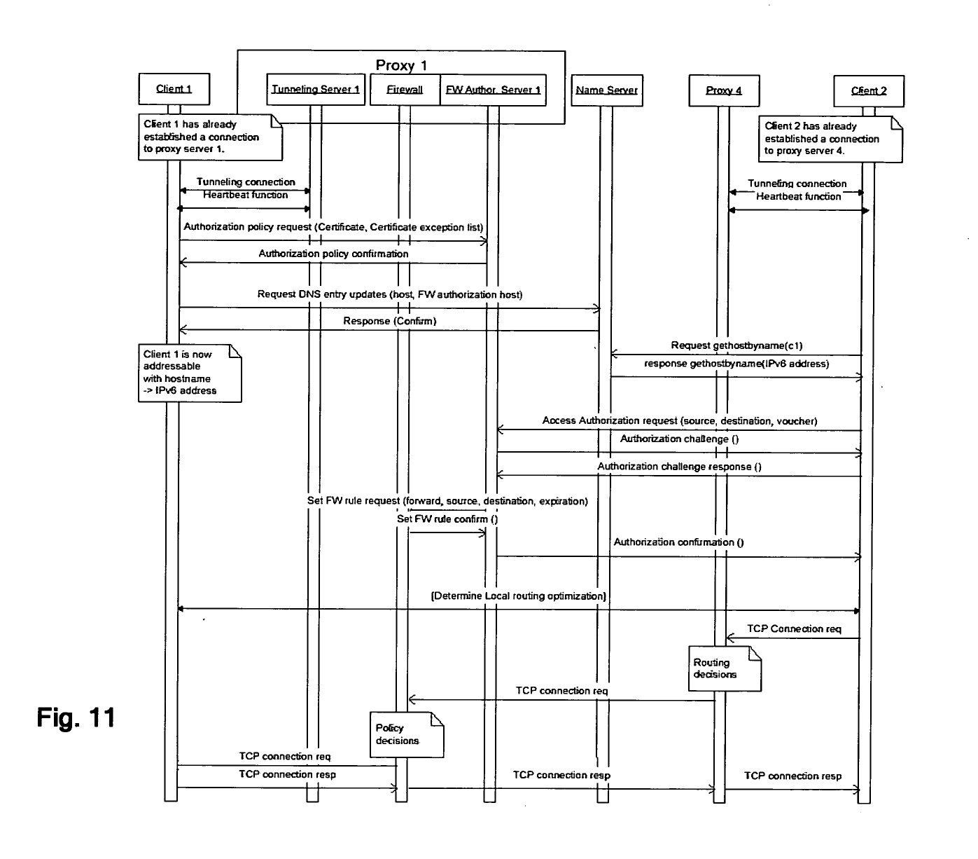

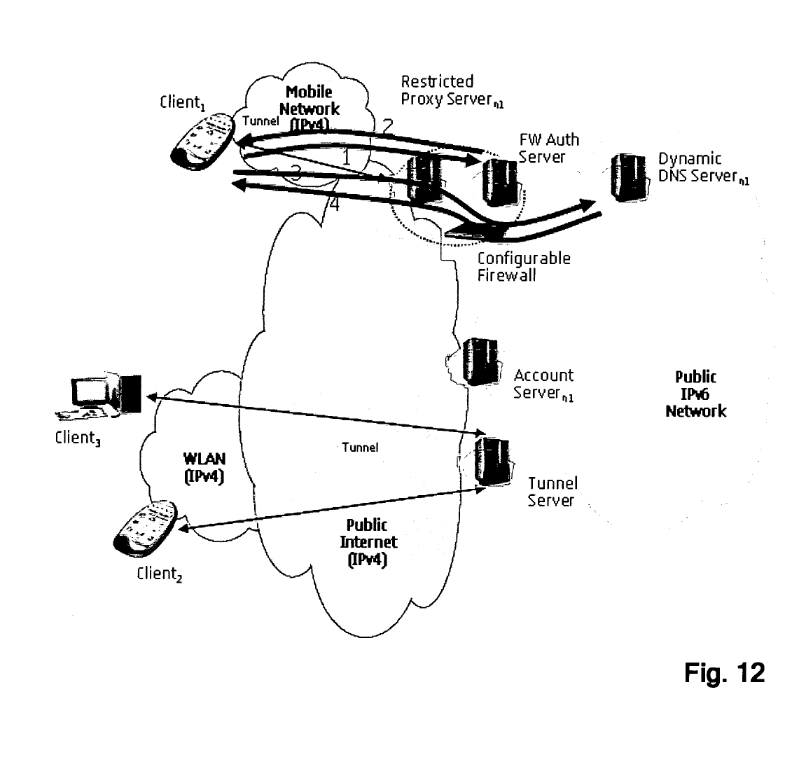

FIG. 12 illustrates how the client connected to proxy server functionality through tunneling server updates information with firewall managing server and updates name server entry, as shown in FIG. 11 (the firewall and firewall authorization server are not relevant for this embodiment, however, all DNS related sequences are valid):

1. Client 1 enables valid clients to connect to it by providing certificate to the FW authorization server. In addition, revocation list is given (validity vs. number of revocation items).

2. Authorization Server configures the Configurable Firewall to enable outbound traffic. It confirms that outbound connections to IPv6 network are now open.

3. Client 1 knows its own IPv6 address, and the IPv6 address of the FW authorization Server. Client 1 updates corresponding own IPv6 address and IPv6 address of the authorization server (corresponding these two hostnames) to name server through the tunnel and firewall.

4. Dynamic DNS server confirms to Client1 that both entries have been updated to name space.

In the following a second embodiment of the invention will be described.

The second embodiment is related to simplifying the procedure required by a consumer when his terminal becomes node in the overlay network described above.

The second embodiment is an extension of the first embodiment but could be utilized to simplify registration in other similar type of networks.

If a (first-time) registration to the overlay network cannot be made simple for the consumers, the usage of the network may be low, and also the value of the overlay network to other parties may be less.

Also, it may be advantageous to handle cases where the terminal has been damaged or lost in a way that does not render the previous hostname and firewall authorization tickets useless.

According to the second embodiment, the registration procedure for joining overlay network should be made as simple as possible. Also examples for how to protect credentials used to make dynamic DNS updates and how to protect the private key used for creating firewall authorization tickets from being lost (in case device is damaged) are outlined.

The list of functionality to be supported by the protocol interface primitives of the CL-PS (Client-Proxy Server) interface as shown in FIG. 3 further comprises registration functionality and procedures.

The protocol interactions according to the second embodiment take place between client 1, Account server and Name server. The functionality handles the initial setup of domain name for user, and configuring the proxy addresses and credentials in the terminal SoftWare.

In an embodiment, registration steps may be carried out as follows:

At first, Client1 contacts to Account Server and requests list of available domain names. Then, Account server provides Client1 with selectable list of domains that Account Server can administrate. Subsequently, end-user selects preferred hostname for domain and requests the Account Server to reserve it for the user. Then, Account Server checks the availability of the requested hostname.domainname from Dynamic DNS Server. When requested hostname is not in use, DNS Server reserves it for Client1 and informs Account Server. Client1 gets from Account Server:

Credidentials to make change requests to Dynamic DNS;

List of available tunneling servers, including available tunneling protocols, access credidentials and access servers used when required.

To activate the account of Client1, additional methods may be used during the process to validate the end-user. This can happen using email, SMS or other means if required.

Registration Procedure (With Server)

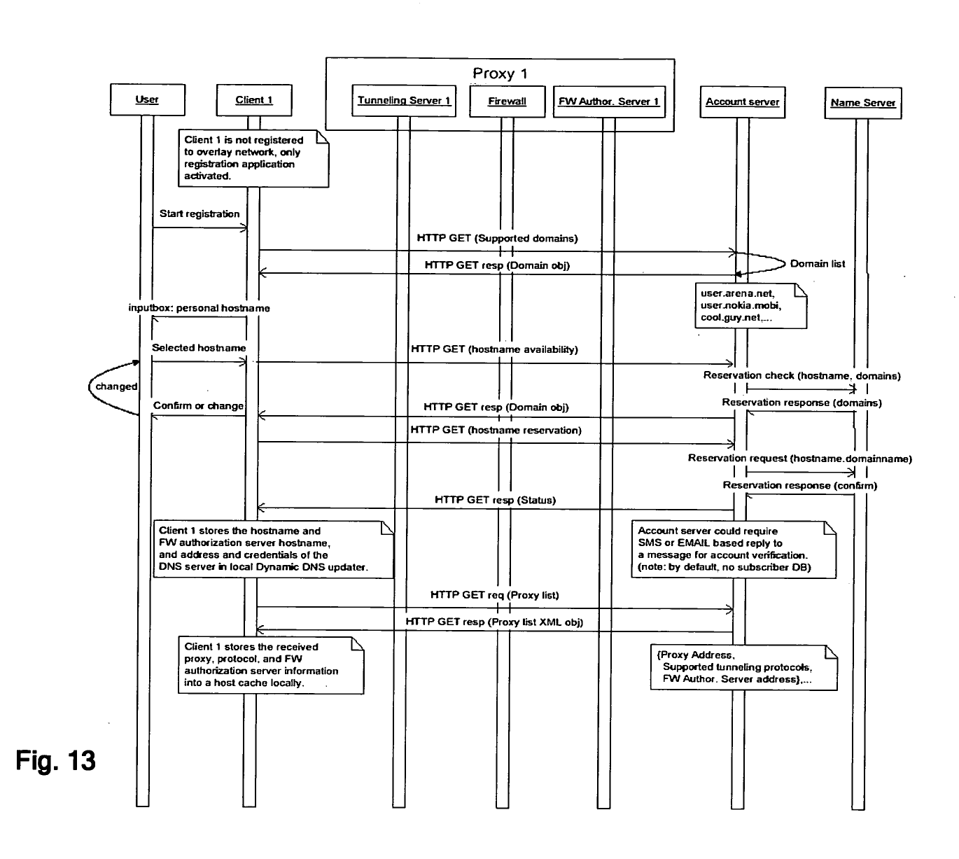

The second embodiment is described by referring to FIG. 13. It is also referred to above-described FIG. 9 as a background for need to store own keys outside terminal node.

According to the second embodiment, there is a specific “account server” which is reachable from the mobile terminal (Party A) that wants to become client in the overlay network.

The access to the account server for consumer may be made browser based, but as there are multitude of browsers with different capabilities, the preferable approach is to have “Overlay Registration application” in the terminal. If the browser-based approach would be utilized, the web server would in worst case have different page for each browser/phone model that accesses it. The usability of browser based approach in such environment is more challenging comparing to making a (UI) tailored application in the terminal.

The registration application may be started by user selection, or it may be started when any application in the terminal tries to access the networking interface provided by the overlay network.

The application may perform the following functions as shown in FIG. 13:

Contacts account server (at predefined hostname) using ordinary networking interface.

Preferably protocol is based on HTTP (HyperText Transfer Protocol) (and SSL) to ensure maximal FW traversal.

Application requests supported domain from the account server.

Application generates hostname (from user's business card information), or asks user to enter hostname.

Application lets user to select one or more of the domainnames to test the hostname with.

Application requests from the account server all user defined combination to check which ones have been reserved, e.g.:
Requested hostname: Petri.Nykanen
Requested device extension: mobile
[Requested auth extension: auth]
Requested domains: moblab.net, n.mobi
Request (for example in HTTP Get/Post) mobile.petri.nykanen.moblab.net, mobile. petri.nykanen.n.mobi
   Similarly, authorization server hostaname may be reserved. In other words, it is another extension with the same domainname, by default this is set to “<device extension>-auth” but can be changed in advanced settings. In the above case it would be “mobile-auth”. This would lead to firewall authorization name “mobile-auth.petri.nykanen.moblab.net”, for example.

Application shows (for example with radio button based one-of-many selection) which hostname+domain names are available, and requests user to select one.

Application reserves from the account server the specific hostname+domainname (from now on referred to as “hostname” only). All hostanames of format <extension>.petri.nykanen.moblab.net are now reserved for this user.

Application stores credentials received from the account server, as well as configuration data for name server.

If the terminal has not the proxy server configuration information (i.e. local host cache information), this information can be requested as well.

User should be asked for cellular phone number, or preferably email address that can be used for account maintenance purposes. For example, credentials for this account would be safe in cases when the device has been lost.

If the role of the account server is made mandatory part of the system, then the account server could also function as storage for the private key(s) generated for the purpose of creating firewall authorization tickets. This would mean that the application also generates the private key for the user, and asks or automatically sends and stores this information to the account server. The purpose of this function would be to make it simple for the user to move the account from one terminal to another even if the terminal has been lost or broken. This approach may in some cases result in the account server becoming potentially a (hostile) control point.

Registration Procedure (Client Centric)

In the following an alternative approach of the second embodiment is described, which aims to be client centric.

The idea is to preconfigure the “overlay registration application” with the credentials needed for access, and the address information of the dynamic DNS server.

The communication with the Dynamic DNS server happens directly or with minimal additional code on the DNS server, that does not require creation of permanent account in separate server. Only hostname+credentials to make dynamic DNS updates are stored.

The above-described interaction that took place with the account server now takes place with the name server.

In case that the terminal is lost, some precautions may be required. For example, user may be asked to backup all keys and credentials to separate memory card not kept inside the terminal or store them beforehand into any persistent and secure storage at home.

Similarly as the address and credentials to access the dynamic DNS server, the address and credentials to access to overlay proxy servers are preconfigured in the terminal. Thus, this information needs not to be requested from the Dynamic DNS server or account server (which does not exist in this alternative).

Protection of Private Data (Stored to External Medium)

Alternative method of storing private data to account server is to enable (and to require) user to store (password protected) object to external storage medium like memory card.

Protection of Private Data (P2P with Personal Private xCard)

Alternative method of storing private data to account server is to generate for the user personal “secret business card” object that contains (password protected) the credentials for the dynamic DNS server, credentials for the proxy tunneling servers, private key(s), and all own hostnames.

This object can be sent over secure (HTTP SSL) connection between own terminals, and would enable:

Storing the private data in more than one device; and

Enabling utilizing same Dynamic DNS hostname (with different extension) between multiple own devices, like:

mobile.jari.mononen.moblab.net

homepc.jari.monen.moblab.net

communicator.jari.mononen.moblab.net

The user should not send this “private business card” to anyone else than to his own personal devices. Even though the receiving party cannot open it without password, the security level cannot be as high as with long keys used in PKI, for example.

Protection of Private Data (With Server)

Alternative method of storing private data to account server would be to generate for the user personal “secret business card” object that contains (password protected) the credentials for the dynamic DNS server, credentials for the proxy tunneling servers, private key(s), and all own hostnames.

A separate server address can be defined (or it is offered as service to the users), and the separate server can store the private data, and contains (separate from account server) the means to request the private data to be sent, received and updated securely.

The second embodiment simplifies steps for the consumer to have his device become a node in the overlay network. Moreover, consumer's private data are protected against loss (in case device is lost, stolen, or broken).

In the following, a third embodiment of the invention will be described by referring to FIGS. 4, 5 and 9.

The third embodiment provides enhancements or functionality in an overlay network client to help it function more effectively in the overlay network described in connection with the first embodiment.

The third embodiment relates to enhancements to how an overlay network client behaves alone or in co-operation with the tunneling server it has set up tunnel with.

Creation of (Multiprotocol) Host (Proxy) Cache

The overlay network can technically work with only one proxy server (comprising tunneling server, firewall and firewall authorization server). These may be logical components of one server. In an alternative embodiment, they can map to physical architecture, and be separate computer systems that communicate with each other (specifically the firewall authorization server with the firewall).

In practice, for load balancing and scalability reasons, it may not be likely that one proxy server serves all the nodes of the overlay network.

Furthermore, it may not be likely that one tunneling technology works in all of the network configurations where the nodes are situated.

The third embodiment aims to create host proxy cache in node (i.e. mobile terminal) where the cache comprises the following information for each of the proxy servers:

Proxy hostname,

Proxy credentials,

List of supported tunneling protocols,

possibly a validity period for the given proxy server,

Related firewall authorization server hostname,

Status data for local heuristics.

This host proxy cache can be requested from any of the proxy servers. The proxy server can indicate

Additions to host cache,

Removal of proxy servers from host cache,

Flushing of host cache and starting with the indicated proxy server.

In addition, the proxy cache information may contain heuristics rules for how the node will behave (optimize for smallest latency, least number of hops, how to prioritize the tunneling protocol selection).

The proxy cache information can be requested by the overlay network client after receiving the information on the first proxy server. This information may be predefined in the registration application or it may be received during registration procedure, or it may be entered in by end user in an advanced settings dialog box.

The request for the proxy cache information happens during the connecting procedures (see FIG. 9). Technically this can be done through HTTP GET to one of the existing proxy servers in the host cache. The received information can be formatted as XML object, and signed in such a manner that the node requesting it can trust the information was received from the correct proxy server.

As shown in FIG. 4:

The node requests for the host proxy cache information.

The node determines optimal proxy based on local heuristics;
Proxy servers are pinged and shortest latency and/or least hops are determined.
Optimization for tunneling protocol is performed that has lowest overhead on the tunneling server. If this protocol does not work, next protocol is selected and connection attempt is made.
As shown in FIG. 5, if a connection is lost, connecting procedures are initiated, and data on connection attempts is stored into the status data in host proxy cache. If connection attempt is unsuccessful, the proxy is marked temporarily as out of order and the selection of optimal proxy for connection is reinitiated. Here it is required to try to get to the same proxy, maybe even with different tunneling protocol if possible, to preserve the IPv6 address the node currently has. However, if this is not possible, then it is required to move on to next potential proxy server.

It is desirable to tune the heuristics the node uses for proxy selection after it has become operational. In the downloaded host cache information rules to set heuristics may be included.

Multiple Concurrent Tunnels From a Node

When tunneling connection is lost, reinitiating the tunnel to the same proxy server, or selecting a new one may cause such delays that they become visible for consumers on application level.

If the node (mobile terminal) has multiple interfaces such as 2.5/3 G packet data, and wireless LAN interface, it may be desirable to setup and maintain multiple concurrent tunnels from the node to one or more proxy servers.

According to the third embodiment, two or more tunneling connections can be set up to same proxy server (through separate interfaces). The proxy (tunneling) server may accept two or more connections with the same hostname and credentials, and may send packets through the interface which either:

Has been last used by the client node.

Has smallest latency or smallest hop count.

Has been indicated by the client node as preferred routing option.

Client node may adopt an approach where it prioritizes lower cost and smaller latency tunnel over other established tunnels.

Routing based on such multiple tunnels may be hidden from the applications when both tunnels terminate in the same proxy (tunneling) server. First multilink protocols were introduced for dialup and ISDN connections to get better throughput over additional PPP-links. In this case multilink usage is mainly targeted for recovering from connection failures (e.g., WLAN link dropping but GPRS still serving) and reducing cost implications of traffic going through charged links (e.g., preferring WLAN link instead of GPRS alternative).

Communication may be setup to have heuristics where a single access is preferred over a second one, for example due to the underlying cost structure, or the quality of service. For example, the WLAN access is preferred over the 2.5 G/3 G access, and packets are always routed through the WLAN interface if tunnel has been established. However, when node leaves the WLAN hotspot, the node will start to use the 3 G packet data interface where tunnel has been kept active (with heartbeat in the tunneling protocol), but basically dormant until the WLAN connection was lost.

According to an alternative example, tunnels to other proxy (tunneling) server are initiated as well. However, in this case, because the proxy servers provide the terminal with different IPv6 address, negotiation between the proxy servers is required, when communication is lost through one interface.

In this latter case the IPv6 address will change (unless one proxy behaves as home agent for the node), and the changing of IPv6 address will be visible to applications and to other nodes. The DNS update function in terminal will need to update the IPv6 address of the mobile to the dynamic DNS server.

According to the third embodiment, the situations where a specific proxy is not reachable are solved with a specific protocol; another proxy service can be selected without disruption. The approach is such, that each tunneling protocol can be handled as “black box”; it is initiated, and will be used if successful. If not, heuristics will select next proxy server and protocol pair and initiate again, and so forth.

Moreover, according to the third embodiment, situations are solved where losing the tunneling connection to a proxy would lead to delays visible to users of the applications that rely on this tunneling connection. Another tunneling connection will be kept as “dormant” backup, and only be utilized when the first one is lost/disconnected.

In other words, there may be logic included in the node to check the active tunneling connection and in case it is not working then either the node or the server re-/initiates the negotiation and establishes another tunnel. As described above, having two communications channels between the node and the server is possible, which related to the negotiation of the tunnel and the tunnel itself.

Moreover, the node may have logic for having different tunnel technologies, and the logic for the keep alive functionality; then in case a tunnel is down it can be re-established using any of the alternative tunneling technologies available.

In the above-described tunnel negotiation mechanisms a possibility of deciding whether the tunnel should be encrypted or not and whether compression should be used within the tunnel depending on the resources in the node or server and the available bandwidth can be included. In this connection, also bearer information may be included as part of the tunnel negotiation so the node can select the right tunnel technology based on the available channel.

Furthermore, the above-described peer to peer mechanism may be available for standard applications i.e. using standard sockets API or similar interface. In addition, the above-described peer to peer tunneling technology may include a wrapper server or interface that will provide standard interface (e.g. sockets) to existing applications.

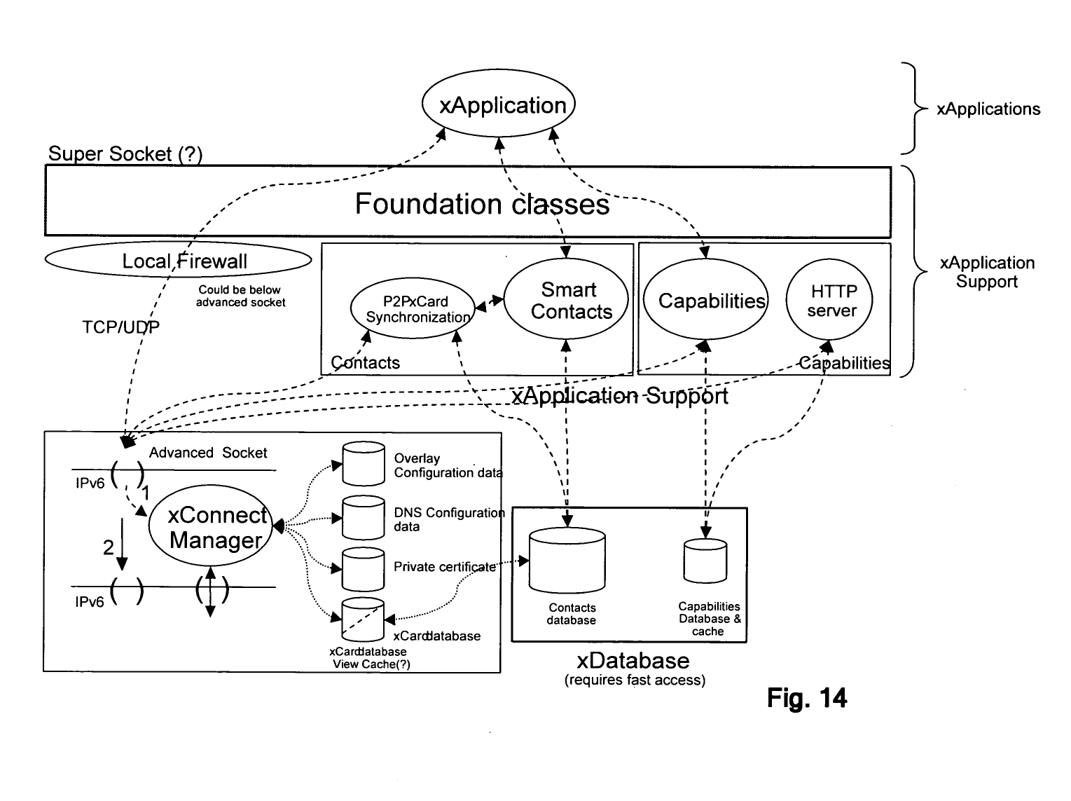

In the following a fourth embodiment will be described by referring to FIGS. 14-17.

The fourth embodiment is related to finding out applications (and services) supported by a node in the overlay network. Nodes that have registered to the overlay network, once they have utilized the firewall authorization voucher/ticket, can communicate on top of the overlay network peer-to-peer. The overlay network basically opens the whole IP port address space between the two devices to utilize, and tunnels communication between the nodes and such ports transparently.

It is assumed that the nodes of the network have different capabilities, and also may support the capability to install software (applications) after purchase of the device. In such situation, two nodes in the network may not know the capabilities of each other, i.e. what are the applications (or service related software application) installed and operational in the other node, and in which ports do those application instances listen for incoming traffic.

The fourth embodiment handles both finding out the services in the other node, and finding out part ports the services/applications are listening. The solution presented by the fourth embodiment aims at solving the problem following the peer-to-peer model.

While many technologies exist for service capability queries, the aim is to show that by combining the capability to query node for its supported services and the connectivity as provided e.g. by the first embodiment highly user-friendly system can be built where the user's device makes the necessary queries automatically and can provide user automated selection (and narrowing of selection) when communicating with one or more other hosts.

In network where the peer-to-peer communication has been enabled, a node (Party A) can initiate communication with another node (Party B) directly. No servers are needed in between for the application level protocol, but rather the communication takes place directly between the two parties.

It is assumed the network is Internet based, and supports concepts of IP address for selecting correct host node (device), and port address for selecting application within the host node.

In this situation, if Party A knows what applications the Party B supports, and it knows the currently valid IP address of Party B, it is possible to send packets to the port the application is listening to. Typically the listening port address has been prior agreed, either to be protocol specific, or application developer has randomly selected a (user configurable) number that his application will use for communication.

However, if Party A does not know what applications the Party B supports, it can only try to initiate communication to a port in Party B it assumes the right application is listening to. Depending on the application-level protocol Party B can or possibly cannot even answer for Party A to confirm there is application listening to the packets sent.

Also, if Party A does not know which port has been selected for the application in Party B, it does not know to what port to initiate the application-level protocol communication.

The fourth embodiment of the invention enables

Party A to directly ask from Party B if this node supports a specific application, or more widely, what applications in general are supported.

Furthermore Party A is enabled to find out the port numbers used by a specific application of Party B.

Still, the knowledge of services/applications supported by Party B is enabled to become only available to such other parties that Party B has given right to do so.

Finally, local caching is used for storing received capability information, and update of the cache is initiated if application-level communication is unsuccessful (meaning that application port it listens to has been changed, or the application has been removed from the terminal (or new terminal has replaced a lost or damaged terminal)).

The fourth embodiment can benefit (or directly utilize) technologies planned for how nodes capable of supporting Web Services (i.e. XML (eXtended Markup Language)/SOAP (Simple Object Access Protocol)) based services can announce their capabilities without centralized UDDI database (through HTTP (HyperText Transfer Protocol) GET to web server, returning XML object containing supported Web Services information).

Capabilities information query and storage may be done by a logical component that is physically located in the node. Alternatively, the logical component may be hosted in some device in the network. For example, a server of the overlay network is caching node's capabilities when it is offline.

It is to be noted that other protocols such as SIP (Session Initiation Protocol) may be used to subscribe and get the node capabilities information. Moreover, the application/service information may be defined as part of a metadata structure that will include ports, IP, URL and possibly security information that the specific applications require for accepting incoming queries.

Capabilities Query as Part of Node's Logical Architecture

A node that is client of the connectivity overlay network as described in the first embodiment may have an architecture as shown in FIG. 14. The capabilities related functionality can be implemented as any other application on top of the connectivity. In such case access control to access a node's capability information is automatically taken care of with the connectivity which allows only those parties to query for capabilities that have valid ticket (firewall authorization voucher) to connect to this node. The exchange of such tickets will be described in the fifth embodiment, but can happen for example as part of business card exchange between two parties.

An application that utilizes the connectivity network of the present invention for its primary connectivity is herein called connectivity application. Such applications have supporting function called herein capabilities support function available for them.

The capabilities support function may provide the following:

Local connectivity applications can query if a port is free or if there already is local connectivity application registered to that port.

Local connectivity applications can register to be available applications/services for other nodes. At the same time the connectivity application may indicate the port addresses it utilizes.

Internal parameters related to connection application application-level protocol or functionality may be inserted into the capabilities information, however, the preferred embodiment is that the capabilities database contains only pairs:

{application unique identifier, version, (port list)}

Local connectivity application can query for application support in remote node. Such query will return the stored pair(s) that match the query.

Internally the capabilities function may store cached data of any of the made queries for future reference. It is implementation specific whether all capabilities of remote device, or only those application queried are locally cached.

When remote party performs a query, the local HTTP server will serve the query as XML object, answering the HTTP GET received from the remote end.

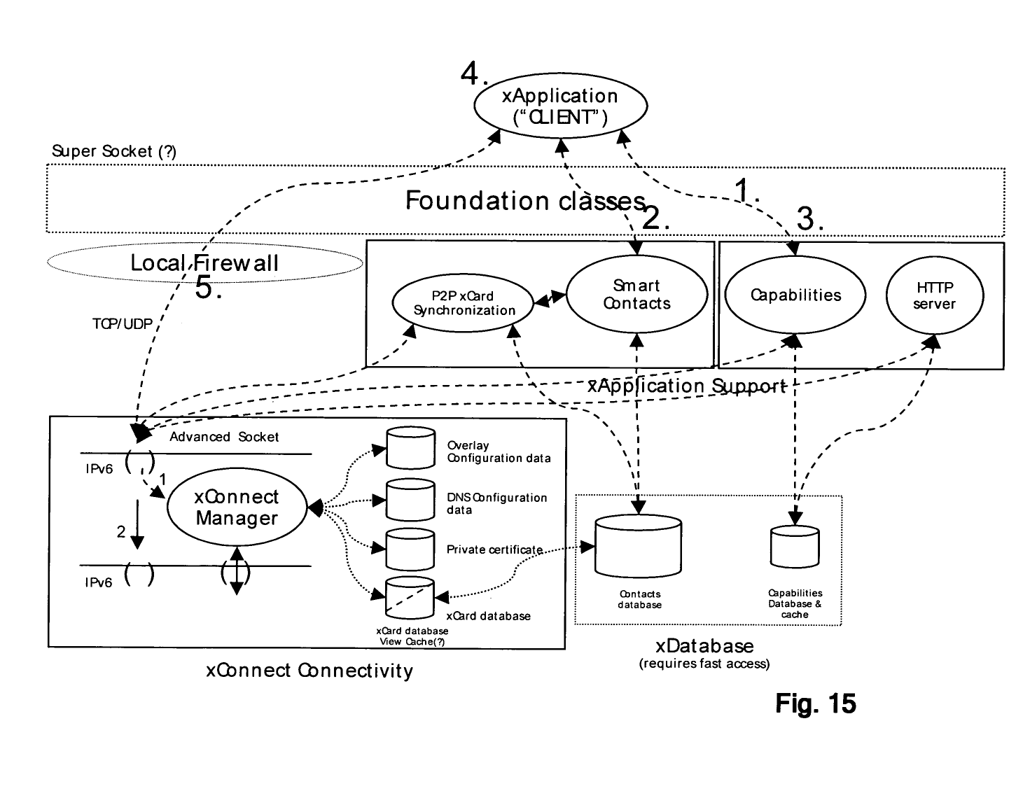

As shown in FIG. 15, the P2P “client” or originating application works as follows:

As indicated by communication 1. in FIG. 15, it is communicated if an application can be contacted by other parties, at install time, own terminal capabilities=Application name+ports are updated. Typically, this does not contain parameters internal to applications, purpose is to have dynamically allocated ports. In communication 2., Party Bs (parties to be contacted) are selected by the application from contacts database. User selects contacts.

In communication 3., it is communicated if in the contacts there are hostnames for which capabilities are not known. This may comprise whether they support this specific connectivity application, and if yes, at which port address(es) the application is located, If this information is not cached then capabilities are queried from each of the hosts. Caching may minimize latencies.

In communication 4., the application may decide or provide user additional selections based on now known capabilities.

And in communication 5., P2P application level communication is initiated with one or more of the selected hostnames.

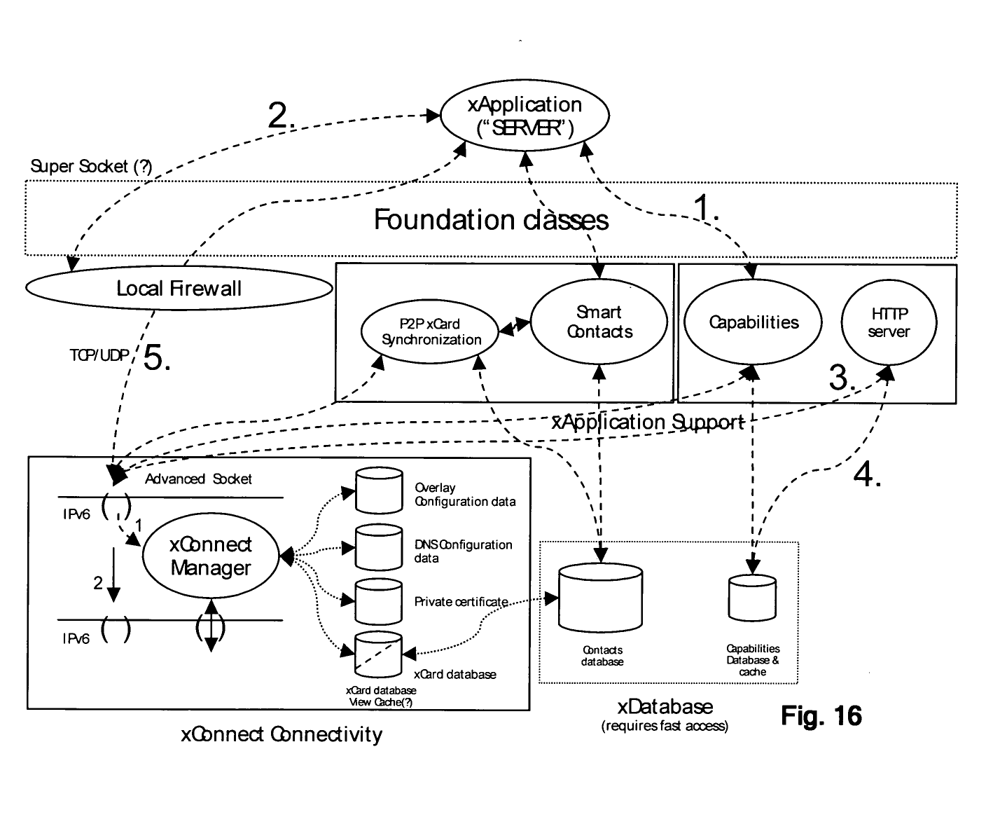

As shown in FIG. 16, the P2P “server” or contacted application works as follows. In communication 1. in FIG. 16, at install time, own terminal capabilities Application name+ports are updated. Typically, this does not contain parameters internal to applications, purpose is to have dynamically allocated ports. In communication 2., if the application can be contacted by other parties, at install time, local firewall is updated to accept incoming communication. If firewall is below advanced sockets, then simply registering a listening daemon can open the port for external communication.

In communication 3., if originating party A does not have the capabilities of contacted Party B then corresponding capability query is made. In communication 4., the capabilities are exposed through HTTP server which uses local database where own capabilities are stored. In practice, HTTP server and Web services type of XML object containing the service data are used.

In communication 5., P2P application level communication is initiated through the port which was found out during the capability query. If the P2P application level communication fails and cached application and port information was used, then a new capability query will be initiated to find out if the capabilities of the other node have changed, for example application removed, identity moved to a new terminal without the application, application temporarily disabled, and so on.

One alternative way of delegating the capabilities functionality as mentioned above is to make the DNS update client in the connectivity architecture to register also a “capabilities” DNS hostname. This hostname may point to the terminal itself or it may point to a server reachable in the overlay network, thus delegating the server functionality. According to this alternative, the node capabilities server is in the net-work and is equivalent to the DNS server. However, the capabilities server can also be a cache in the overlay proxy server that keeps the node information when it is offline.

The benefit of such approach is that the capabilities query does not cause traffic to the node (terminal) which capabilities are queried for. However, there is one more DNS hostname to register for per each terminal, the capabilities information of the terminal and the server have to be synchronized, and a new access control method to limit who has access to the capabilities information in the server is required.

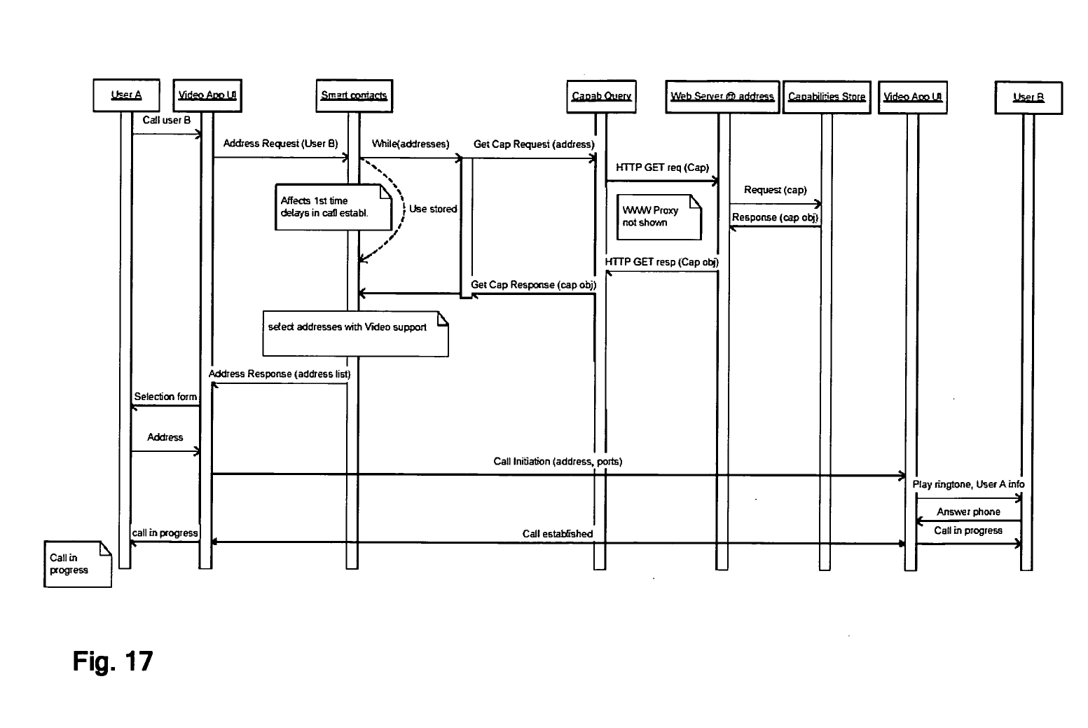

FIG. 17 shows a Parking lot—CL-CL Service Capability Query protocol example.

The fourth embodiment provides a way to expose information about terminal's supported application capabilities peer-to-peer, only to those peers the owner of the node has authorized to communicate with his node.

The list of applications can change dynamically, cached version of the capability data is used, but if new application is queried for, or the application is not present anymore, new query will be made and the new results cached, resulting in fast functionality at user interface. It is expected that removal of connectivity applications takes place more seldom than installation of new applications.

Preferably the first query for capabilities and storage of the capability data related to a hostname is made when the parties exchange with each other the tickets (that authorize accessing the capabilities information, through the firewall in the network and/or terminal).

The fourth embodiment provides dynamic allocation of ports for services instead of static mapping and a method to query what kind of capabilities are available in another peer. There is no need for centralized repositories for device capabilities.

In the following a fifth embodiment will be described by referring to FIGS. 6, 11, 18 and 19.

The fifth embodiment is related to filtering of unwanted packets when a receiving node is addressable and reachable. This embodiment is not limited to mobile phones; it can be widely utilized in many types of terminals. The fifth embodiment may be utilized as extension to the above embodiments, e.g. the first embodiment which describes how for example mobile terminals can be made addressable and reachable.

However, it is important to realize that the ticket or shared secret based approach of the fifth embodiment may as well be utilized separately from the above embodiments.

The fifth embodiment combines technology blocks such as firewall, tickets (or vouchers or shared secret) in a way that the combination may provide more value than the technology blocks each alone.

In the fifth embodiment it is described how firewall(s) and tickets/shared secret exchanged between nodes (parties A and B) can be used to weed out unwanted incoming traffic before it causes costs to the receiving party (especially in case of cellular packet network where the receiving party pays for incoming traffic).

If packets are routable for example to a mobile terminal, the receiving party may have to pay for the incoming traffic. However, the network does not provide any means to allow or block incoming traffic based on party sending the packets or the application (port) for which the packet is intended. If mobile terminals become addressable and reachable by other nodes in the Internet (or on an overlay network set up on top of the Internet), unless the network and client software implementations are under strong control, it is not possible to keep nodes either from sending packets to any node in the network (not knowing the receiver) or to keep nodes from targeting specific hostname. Thus, filtering out of incoming packets is an issue.

As mentioned above, the fifth embodiment is to combine technologies of firewall (network side and in special case, on the node itself), and tickets (based on vouchers and/or shared secret between the nodes). The fifth embodiment does not require a “Managed” or safe underlying network. The trust relations needed are only between the node and the entity in network handling the firewall function, and between the nodes that have either exchanged the shared secret, or otherwise generated a ticket that enables the other specific node to make firewall traversal when connecting the node.

As described in connection with the first embodiment, a node has joined the overlay network, and established tunneling connection with a tunneling server (function) of a proxy server. The proxy server contains two new functionalities, firewall and firewall authorization/authentication server. Here, the authorization/authentication server is called firewall managing server.

The firewall is programmed by default to block all incoming traffic towards the node (it may also by default block all communication from the node until the node has provided it credentials, this is optional).

In general, the firewall may as well be a firewall on the administrative boundary of a company, and have nothing to do with the connectivity network of the first to fourth embodiments.

Authorization where Party B gives (directly or indirectly through a third party) rights to Party A may be based on multitude of approaches. One general approach is to utilize a shared secret where both nodes know something nobody else does, and by checking credentials sent by the other party the authorization is given.

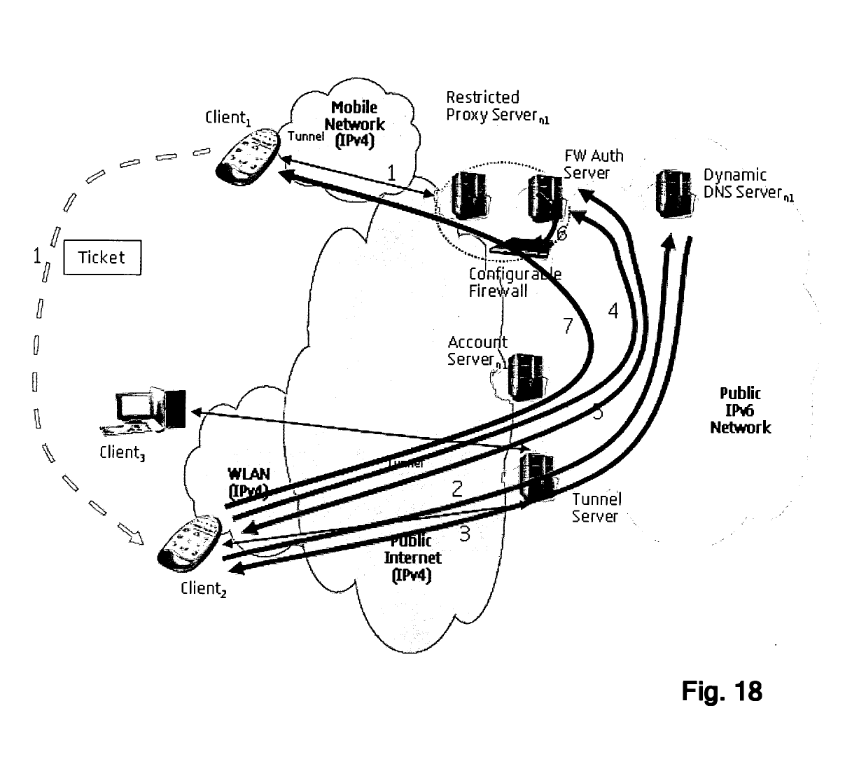

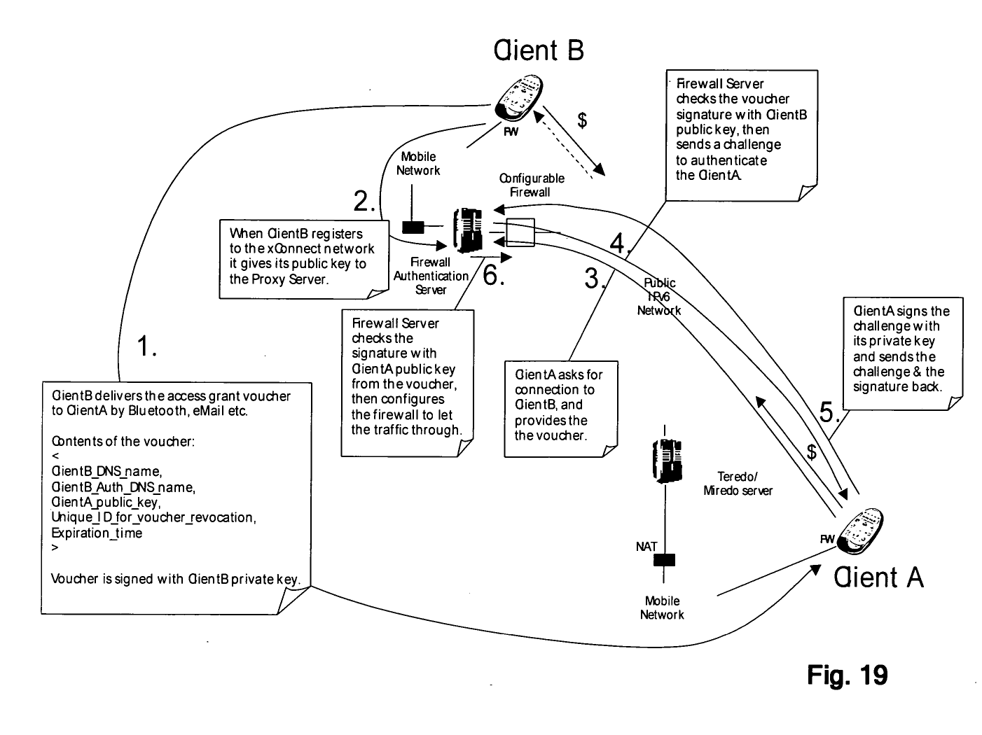

Another approach is to use public key cryptography in a way that Party B provides party A a signed ticket, and this ticket is checked against Party B's public key when Party A needs to be authorized, as shown in FIGS. 18 and 19.

As shown in FIG. 19, in communication 1. Client B delivers an access grant voucher to Client A by Bluetooth, eMail, or the like. In communication 2., when Client B registers to the network it gives its public key to the Proxy Server. In communication 3., Client A asks for connection to Client B and provides the voucher. In communication 4., the firewall managing server checks the voucher signature with Client B public key, and then sends a challenge to authenticate the Client A. In communication 5., Client A signs the challenge with its private key and sends the challenge and the signature back to the firewall managing server. In communication 6., the firewall managing server checks the signature with Client A public key from the voucher, and then configures the firewall to let the traffic through.

The ticket is based on certificates that identify a user (or a device). The Certificate is trusted by out of band means by the issuer of the ticket.

The Ticket typically includes parameters such as

Hostname of Service Provider

URL of Service Provider authorization server

Certificate of Service Provider (original issuer, optional)

Certificate of consumer

Validity period

Forwarding rules (e.g. how many steps are allowed)

Signature of ticket issuer (over the complete ticket)

Unique ticket identity

The Certificate may be issued by a Certificate Authority, or it may be self-signed. The level of trust defines the usage space and conventions. In many cases, especially in peer to peer applications, it is enough that the issuer of the ticket knows that the intended consumer is in possession of the certificate, and trust the consumer to keep the associated private key secret.

The ticket can be defined to be valid for a dedicated consumer only, or it can be defined to allow for forwarding. The forwarding allows for delegation of ticket distribution. When a ticket is forwarded the original ticket is appended with the certificate of the new consumer, and this new ticket is singed by the private key of the forwarding consumer. This mechanism creates a forwarding trail in the ticket that can be evaluated by the Service Provider when the ticket is used for service authorization.

The ticket is signed by the issuer, and thus an atomic unit. It includes the absolute expiry time relative to the Service Providers clock. Thus, if a ticket is forwarded it still expires at the exact time defined in the original ticket.

The ticket distribution can be executed in several different contexts, for example by means of messaging (email), online transaction, or in proximity environments (like Bluetooth or Infrared).

The service provider may at any time revoke tickets. This can be done either by revoking a specific ticket, or by revoking all the tickets that are issued to a specific certificate. Both of these revocation methods make it possible to revoke specific tickets, or chains of tickets created by forwarding.

There are situations, for example online ticket distribution, where the consumer does not yet have a ticket. It is then possible to out of band deliver a shared secret, such as a PIN code, to the consumer, and temporarily configure the firewall managing server to accept this particular shared secret.

In an environment such as the connectivity network described in the first to fourth embodiments, utilizing only a firewall with (semi) static rules for filtering unwanted incoming packets is not appropriate. There may be specific cases where access should be provided from home PC or some other system in the Internet to access always the mobile phone, but even in those cases the IP address may change, and a hostname would be more preferably identified. However, this would lead to gethostbyname type of queries by the firewall affecting its scalability greatly.

Utilizing only authorization end-to-end between nodes may not enable filtering unwanted packets before they enter the radio interface, incurring costs to the receiving party.

It is the combination presented by the fifth embodiment that can solve the stated problems:

A firewall is placed in the network. All overlay communication towards node (Party B) goes through this firewall. The firewall may be optimized to handle the following type of rules: 128-bit IPv6 source address, 128-bit IPv6 destination address, drop or forward, and validity period for forwarding.

A logical entity called Firewall managing server is placed in the network. This entity may have two functions, verification/authentication server and authorization server. The firewall managing server may be part of the firewall. In an alternative, it is a separate entity as this may enable better scalability of the firewall.

As shown in communication 1. in FIG. 19, Party B has provided party A “a ticket” that authorizes Party A to access it through the firewall managing server. The ticket related information comprise:
Hostname of the Party B
Hostname of the authorization server Party B utilizes (could be fixed, but prerably hostname based)
Ticket credentials (shared secret or preferably public key based approach)
Ticket validity period (should be long to avoid unnecessary traffic, but for special cases like Party A only “visiting for a day” can be set for short time period).

Party B keeps its own hostname, and the hostname of the Firewall managing server always up-to-date when it is connected to the overlay network. The overlay network configuration has provided it address pair of proxy (tunneling) server and firewall managing server. Party B may set the hostname of the Firewall managing server to invalid address 0000:0000: . . . if it does not require authorization—thus indicating to any connecting party that the authorization process can be terminated.

Party B provides to the authorization server function of firewall managing server its public key(s) used for verification of the remote host authorization attempts (cf. communication 2. in FIG. 19). In an alternative, the public key (or shared secret) is stored into the firewall managing server.

As shown in communication 3. in FIG. 19, when Party A wants to initiate communication with Party B, it needs first to send the ticket it received from party B to the firewall managing server (the currently valid firewall managing server address is found by having its hostname in the ticket, and at runtime Party B updates the DNS information where this hostname points to. In an alternative, the hostname may be static.

When the authorization server function of the Party B's FW managing server receives over a connection the ticket from A, it will make authorization challenge to Party A. This may be done to ensure that Party A is really the party A that the ticket was generated for (cf. communications 4, 5 in FIG. 19).

If authorization challenge is successful, the FW managing server will set firewall rule to accept packets from the Party A's IPv6 address to Party B's IPv6 address (cf. communication 6 in FIG. 19). A validity period can be set.

The result is that only those nodes that have Party A's IPv6 address or which can successfully spoof source address, can send packets over the radio interface to party B.

Because a secure end-to-end connection (based on SSL, IPSEC, or other technology) is not provided, this provided level of security is only used for filtering unwanted packets.

If during the handshake between Party A and the Firewall managing server additional credentials are created, these can easily be used to set up secure end-to-end connection if needed.

In the following an enhancement of the fifth embodiment will be described.

Considering a case where a terminal (Party B) is connected through access that does not have incoming traffic implications, it can set the address of its hostname for firewall managing server to invalid address. This would effectively give possibility to any node (Party A) to send packets to this node, which may not be desirable.

Another approach is to implement in the Party B:

Local Firewall that can be controlled similarly as the above-described firewall in the network, i.e., with the setting of firewall rules for dropping or forwarding packets.

Local Firewall managing server.

Party B updates the hostname in the dynamic DNS server to point to its current IPv6 address (i.e., the hostname of Party B's node and the firewall managing server hostname both point to the IPv6 address currently valid for Party B node).

Unless Party A has got authorization from the local Firewall managing server of Party B, the local firewall in Party B's node will not forward packets from Party A's IPv6 address to any of the applications.

This provides IPv6 address granularity for the Party B to weed out unwanted packets, and to base the approach on the same ticket paradigm as with the “network supported” case described above.

This may not solve the filtering of incoming packets before they enter the radio interface of Party B. However, it may still provide value by limiting what parties can send packets to Party B even if it is connected over link where there is no cost implications for incoming packets (for example, to limit strain on batteries).

Another enhancement of the fifth embodiment is for Party B to generate more than one type of tickets that are provided to other parties, including Party A. The approach is similar to the enhancement case above. However, additional functions are needed in terminal of Party B as follows:

Generation of multiple concurrently valid tickets

Local association of ticket to applications that it enables, for example Visitor ticket only provides access to mobile web server to view my pictures of share folder.

Firewall with the rules of format:
IPv6 Source IP address
IPv6 Destination IP address
IPv6 Destination Port address
Block/forward
Validity
Firewall managing server which identifies the ticket category and can locally look up and open the ports that this ticket category is allowed to access.

In the following a sixth embodiment of the invention will be described.

The sixth embodiment provides enhancements or functionality in an overlay network client to help it function more effectively in the connectivity overlay network.

Enhancements are presented to how a connectivity overlay network client behaves alone or in co-operation with the tunneling server it has set up tunnel with.

Trusted Client Application Sharing

The method and functionality to discover what kinds of capabilities are available in other overlay network client are described in the fourth embodiment. When, for example, originating “client A” wants to establish a video conference call with another “client B”, according to the fourth embodiment, it can make a query to figure out whether the “client B” is capable of receiving the video conference call, and in case it does, in what port it is listening for incoming connections.

In addition to the service capabilities query mechanism, in the fifth embodiment a method for creating trust relationship between “client A” and “client B” is described. In this embodiment self-signed certificates are used to create trusted vouchers to allow access to another terminal through network elements enforcing access control. This very same signing capability can also be utilized in creating signed file transfer packages stating that the content is coming from authenticated source and the content has not been changed during the transfer. Using the public key from the self-signed certificate it is possible to verify that the content has really received from trusted source. It is noted that the word “content” is to be understood here in wide scope, possibly containing many kinds of information shared among network clients, such as executable applications, text, audio, video or other information in digital format.

Combining these two mechanisms it is possible to build a trusted application sharing environment. As an example, when “client A” wants next time to send a push-to-talk radio message to “client B”, and makes the capability query from “client B” discovering that “client B” does not have the required application available to support incoming push-to-talk messages, “client A” can encapsulate the required plug-in application with signed certificate and offer the package to “client B”. Then “client B” receives a notification giving the possibility to end-user for accepting or denying the new plug-in provided by “client A”. If “client B” trusts for the “client A” (and optionally the whole chain of signed certificates, starting from the provider of the plug-in software, through the steps how application has been forwarded until the “client A”), end-user can initiate the downloading and installation of the required plug-in application.

Additional Trust and Quality Model

When the application or any other message or content is shared in overlay network between the clients, another addition can be made for shared packages. It is possible to include trust level indication and further sharing information to signed packages. For example, when sharing controls are implemented, content may be tagged with control labels, such as:

Not possible to copy further (e.g., commercial software not to be shared)

Content can be shared next N steps (until no more sharing steps)

Personally targeted (hand picked persons to be able to open the content)

I have checked this and it is OK (checked for viruses, given with rank of quality)

Use with your own risk (do you trust the sender?)

These kinds of rankings can be then utilized either among the end-user society, as a public distribution channel or even commercially when preventing the distribution for one and only step from possible charged download site. In addition, when the content is ciphered, it is possible to create “inner citadels” that can share content with trusted parties without concern of leaking the content for wider audience. For example, one of the end-users can record with own mobile device a demo recording from band trainings and personally target the file to be shared among band members, being sure that it will not to be shared and leaked out of group before the song is ready to be presented in school concert.

Community Effect

The above-described method can be used to include a chain of signatures and additional labels for the shared content. This enables creation of “community effect” increasing the value of shared content. In basic case, if an interesting application is received from a trusted friend, one is probably more willing to open and install it to one's device, when it has been already tested by trusted person, when compared to case that the application is received from unknown party. However, this can be taken further. If a recommendation to buy excellent vintage wine for celebration dinner is received and it has been originated from a person who is well known of good wine judging, and in addition there is chain of comments from close community voting that the wine is really exceptional, this might add value for the message received. The idea of adding value using community effect can be built into the chained smart sharing concept, however indications in user interface of network client and how the functionality is either made transparent but still available needs to be implemented.

The sixth embodiment solves the situations where a client of overlay network does not have a required application to handle the incoming connection. Using smart sharing the required client application can be transferred to another end with embedded level of trust, requiring that application or binary level compatibility is taking place between sharing and receiving clients.

Moreover, additional trust and quality model are provided. The trust level can be embedded to the transferred content. A mechanism is introduced to limit the way that shared content gets distributed.

In addition, the trust and sharing control mechanism may be expanded to include additional information for commenting and voting the shared content chain. When additional comments and possible votes of the quality are included into the shared content and information is passed through the chain of sharing, community effect can take place and add value for the shared content.

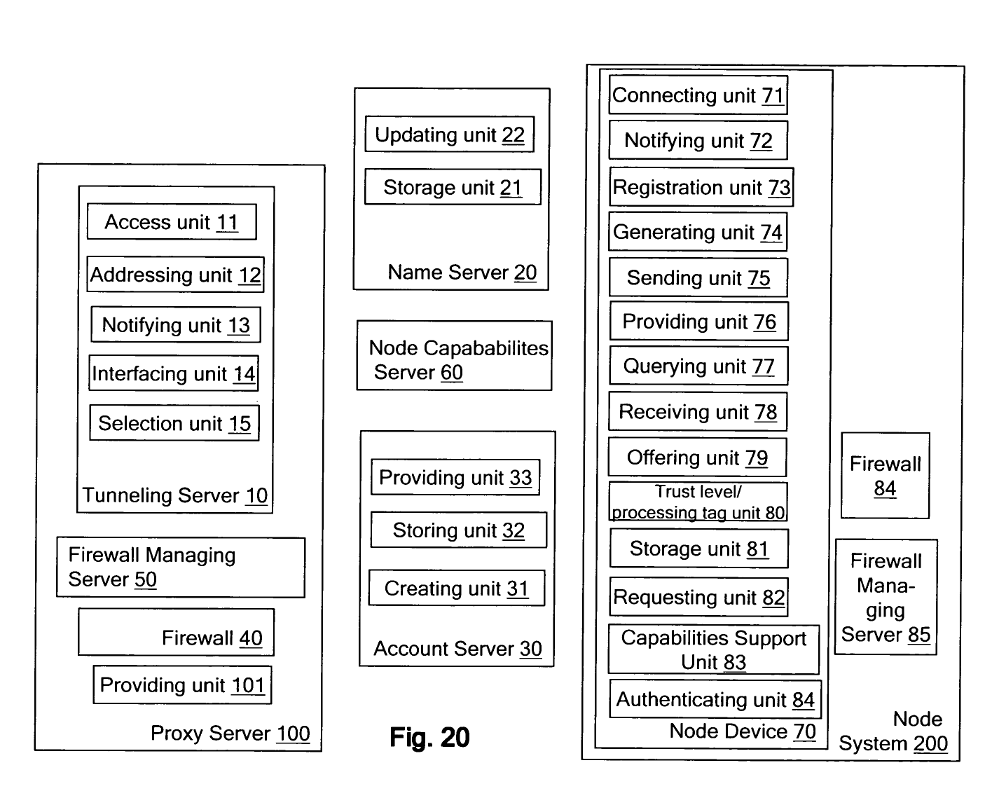

In the following the general concepts of the first to sixth embodiments are outlined by referring to FIG. 20. According to the first embodiment, the present invention presents a communication network for providing seamless peer-to-peer connectivity between nodes or terminals of different communication network environments. The communication network comprises at least one tunneling server 10 comprising an access unit 11 for providing access to the communication network, and an addressing unit 12 for assigning a dynamic address of a first addressing scheme routable in the communication network to a node connecting itself to the tunneling server, the node having a fixed address of a second addressing scheme, and storing at runtime an association between the fixed address of the second addressing scheme and the dynamic address of the first addressing scheme.

The communication network may further comprise at least one name server 20 available to other nodes in the communication network. The name server 20 comprises a storage unit 21 for storing associations between dynamic addresses of the first addressing scheme and fixed addresses of the second addressing scheme, and an updating unit 22 for updating the associations upon notification of a change of the dynamic addresses.

The tunneling server may further comprise a notifying unit 13 for notifying a change of the dynamic address to the name server 20.

According to the second embodiment, the communication network of the first embodiment further comprises at least one account server 30 comprising a creating unit 31 for creating the fixed address and/or providing an address of the tunneling server 10. Moreover, the account server 30 may further comprise a providing unit 33 for providing firewall managing server information to the node.

According to the third embodiment, the communication network of the first embodiment further comprises at least one proxy server 100 comprising the at least one tunneling server 10, a firewall 40 and a firewall managing server 50. The proxy server further comprises a providing unit 101 for providing information about the proxy server 100 to the node.

According to the third embodiment, the tunneling server may further comprise an interfacing unit 14 for accepting at least two connections with the same fixed address, and a selection unit 15 for selecting one of the at least two connections for sending data packets to the fixed address.

According to the fourth embodiment, the communication network of the first embodiment further comprises at least one node capabilities server 60 for storing information about applications and/or services of the node available for other nodes of the communication network and related ports used for the applications and/or services. The node capabilities server 60 may comprises a logical component physically located in a node or a device of the communication network, the device comprising at least one of a name server and a proxy server.

According to the fifth embodiment, a communication network is presented for providing connectivity between nodes, the communication network comprising a firewall which all communication towards a first node has to go through, for storing rules for accepting packets from addresses of remote nodes to an address of the first node, and a firewall managing server for receiving public keys of the first node used for verification of remote nodes authentication attempts, receiving a ticket from a remote node, performing authentication challenge to the remote node based on the ticket, and if the authentication challenge is successful, setting the firewall rules to accept packets from an address of the remote node to the address of the first node.

Adopting the fifth embodiment to the first embodiment, the firewall 40 comprises the above features of the firewall, and the firewall managing server 50 comprises the above features of the firewall managing server.

According to the fifth embodiment, the communication network may comprise at least one account server 30 comprising a providing unit for providing firewall managing server information to the node.

Moreover, the account server 30 may comprise a storing unit 32 for storing the private keys.

Furthermore, according to the fifth embodiment, a firewall managing server is provided which comprises a receiving unit (not shown) for receiving public keys of a first node used for verification of remote nodes authentication attempts, receiving a ticket from a remote node, performing authentication challenge to the remote node based on the ticket, and if the authentication challenge is successful, setting rules of a firewall which all communication towards a first node has to go through to accept packets from an address of the remote node to the address of the first node. The receiving unit may set the rules of the firewall by using NAT or NAPT configuration change.

A terminal or node device 70 for use in a communication network environment comprises a connecting unit 71 for connecting the terminal 70 to a tunneling server, e.g. the tunneling server 10 of the communication network of the first embodiment, the node device 70 having a fixed address of a second addressing scheme, thereby getting assigned a dynamic address of a first addressing scheme routable in the communication network.

The node device 70 may further comprise a notifying unit 72 for notifying a name server of the communication network available to other nodes in the communication network of the dynamic address assigned.

According to the second embodiment, the node device 70 further comprises a registration unit 73 for contacting a server of the communication network for getting assigned the fixed address and/or for obtaining an address of the tunneling server. The server may be an account server e.g. the account server 30 creating fixed address identity for the terminal 70. Alternatively, the server may be a name server e.g. the name server 20 available to other nodes in the communication network.

According to the second embodiment, the node device 70 may further comprise a generating unit 74 for generating a personal object for a user of the terminal, the personal object containing private data, and a sending unit 75 for sending the personal object to a storage unit for storing the same over a secure connection.

According to the third embodiment the node device 70 may further comprises a storage unit 81 for storing information about at least one proxy server 100 of the communication network, the at least one proxy server 100 comprising the tunneling server 10, a firewall 40 and a firewall managing server 50.

According to the third embodiment the node device 70 may further comprise a requesting unit 82 for requesting the information from the at least one proxy server 100.

According to the third embodiment the connecting unit 71 may provide at least two connections to the tunneling server 10, and the receiving unit 78 may receive data packets via one of the at least two connections from the tunneling server 10.

According to the third embodiment, the connecting unit may provide at least one further connection to at least one further tunneling server of the communication network, and the receiving unit 78 may receive data packets via the connection from the tunneling server 10 or via one of the at least one further connection from one of the at least one further tunneling server.

According to the fourth embodiment, the node device 70 comprises a capabilities support unit 83 for storing information about applications and/or services of the node device 70 available for other nodes of the communication network and related ports used for the applications and/or services.

According to the fourth embodiment, the querying unit 77 may automatically query capabilities of other nodes of the communication network and store queried information about applications and related ports. The querying unit may query the capabilities using at least one of the protocols XML/SOAP, HTTP and SIP.

According to the fifth embodiment,a node is provided for use in a communication network for providing connectivity between nodes. The node comprises a providing unit for providing a ticket to a remote node of the communication network, the ticket authenticating the remote node to access the node through a firewall of the node.

Adopting the fifth embodiment to the first embodiment, the node device 70 comprises a providing unit 76 for providing a ticket to a remote node of the communication network, the ticket authenticating the remote node to access the node device through a firewall of the node device. The ticket may be valid for a limited period of time.

Moreover, according to the fifth embodiment the node 70 may comprise a generating unit e.g. the generating unit 74 for generating public keys used for verification of remote host authentication attempts, and a sending unit e.g. the sending unit 75 for providing the public keys to the firewall managing server.

The sending unit 75 may provide the private keys to an account server e.g. the account server 30 creating fixed address identity for the node e.g. the node device 70.

According to the fifth embodiment the node such as the node device 70 may be part of a node system 200 for use in a communication network for providing connectivity between nodes, the node system 200 comprising a firewall 84 which all communication towards the node has to go through, for storing rules for accepting packets from addresses of remote nodes to an address of the node, a firewall managing server 85 for receiving public keys of the node used for verification of remote host authentication attempts, receiving a ticket from a remote node, performing authentication challenge to the remote node based on the ticket, and if the authentication challenge is successful, setting the firewall rules to accept packets from an address of the remote node to the address of the node.

The node system may comprise a providing unit e.g. the providing unit 76 for providing multiple concurrently valid tickets of different categories to nodes of the communication network, a ticket authenticating a remote node to access the node through the firewall, the kind of access depending on a ticket category, wherein the firewall managing server 85 may identify the ticket category and set the firewall rules in accordance with the identified ticket category.

According to the sixth embodiment, the node further comprises a querying unit e.g. the querying unit 77 for querying capabilities of other nodes of the communication network and storing queried information about applications and related ports, a receiving unit e.g. the receiving unit 78 for receiving a ticket from a remote node, the ticket containing a self-signed certificate with a public key, that can be used for proving that an application, which has been sent, originates from the node that gave the ticket, and an offering unit e.g. the offering unit 79 for offering an application to the remote node, signed by the node, when the remote node is missing an application/service, resulting in a lack of capability that was queried. The ticket may be valid for a limited period of time, and the node device 70 may further comprise an authenticating unit 84 for authenticating the node to access the remote node, the authenticating unit configured to renew the authentication periodically.

According to the sixth embodiment the node may further comprise a trust level/processing tag unit 80 for adding a trust level indication and/or adding processing tags to contents shared between the node and the remote node, wherein the receiving unit 78 may receive a content with trust level indication and/or processing tags from other nodes of the communication network, and show the trust level, and/or process the content in accordance with the trust level and/or the processing tags.

According to an embodiment of the invention, a method is provided comprising providing access to a communication network providing seamless peer-to-peer connectivity between nodes of different communication network environments, and assigning a dynamic address of a first addressing scheme routable in the communication network to a node accessing the method, the node having a fixed address of a second addressing scheme, and storing at runtime an association between the fixed address of the second addressing scheme and the dynamic address of the first addressing scheme. The method may further comprise notifying a change of the dynamic address to a name server available to other nodes in the communication network. In addition, the method may further comprise accepting at least two accesses with the same fixed address, and selecting one of the at least two accesses for sending data packets to the fixed address.

Moreover, according to a further embodiment of the invention, a method is provided comprising storing associations between dynamic addresses of a first addressing scheme routable in a communication network providing seamless peer-to-peer connectivity between nodes of different communication network environments and fixed addresses of a second addressing scheme, and updating the associations upon notification of a change of the dynamic addresses.

Moreover, according to a further embodiment of the invention, a method is provided comprising creating a fixed address and/or providing an address of a tunneling server to a node of a communication network providing seamless peer-to-peer connectivity between nodes of different communication network environments, the tunneling server providing access to the communication network. The method may further comprise storing private keys used for verification of remote host authentication attempts. In addition, the method may comprise providing firewall managing server information to the node.

Moreover, according to a further embodiment of the invention, a method is provided comprising receiving public keys of a first node of a communication network providing connectivity between nodes, the public keys used for verification of remote nodes authentication attempts, receiving a ticket from a remote node, performing authentication challenge to the remote node based on the ticket, and if the authentication challenge is successful, setting rules of a firewall which all communication towards a first node has to go through to accept packets from an address of the remote node to the address of the first node. The rules of the firewall may be set by using NAT or NAPT configuration change.

Moreover, according to a further embodiment of the invention, a method is provided comprising storing information about applications and/or services of a node of a communication network providing seamless peer-to-peer connectivity between nodes of different communication network environments, which applications and/or services are available for other nodes of the communication network, and related ports used for the applications and/or services.

Moreover, according to a further embodiment of the invention, a method is provided comprising connecting a node to a tunneling server of a communication network providing seamless peer-to-peer connectivity between nodes of different communication network environments, the node having a fixed address of a second addressing scheme, thereby getting assigned a dynamic address of a first addressing scheme routable in the communication network. The method may further comprise notifying a name server of the communication network available to other nodes in the communication network of the dynamic address assigned. In addition, the method may comprise contacting a server of the communication network for getting assigned the fixed address and/or for obtaining an address of the tunneling server. The method may also comprise generating a personal object for a user of the node, the personal object containing private data, and sending the personal object to a storage unit for storing the same over a secure connection.

Information about at least one proxy server of the communication network may be stored, the at least one proxy server comprising the tunneling server, a firewall and a firewall managing server, and the information may be requested from the at least one proxy server. At least two connections to the tunneling server may be provided, and data packets may be received via one of the at least two connections from the tunneling server. Moreover, at least one further connection to at least one further tunneling server of the communication network may be provided, and data packets may be received via the connection from the tunneling server or via one of the at least one further connection from one of the at least one further tunneling server. In addition, information about applications and/or services of the node available for other nodes of the communication network and related ports used for the applications and/or services may be stored.

The method may further comprise automatically querying capabilities of other nodes of the communication network and storing queried information about applications and related ports. The capabilities may be queried using at least one of the protocols XML/SOAP, HTTP and SIP. Furthermore, the method may comprise providing a ticket to a remote node of the communication network, the ticket authenticating the remote node to access the node through a firewall of the node.

Moreover, according to a further embodiment of the invention, a method is provided comprising providing a ticket to a remote node of a communication network providing connectivity between nodes, the ticket authenticating the remote node to access a node through a firewall of the node.

Public keys used for verification of remote host authentication attempts may be generated and the public keys may be provided to the firewall managing server. The public keys may be provided to an account server creating fixed address identity for the node.

According to a further embodiment of the invention, capabilities of other nodes of the communication network may be queried and queried information about applications and related ports may be stored, a ticket from a remote node may be received, the ticket containing a self-signed certificate with a public key, that can be used for proving that an application, which has been sent, originates from the node that gave the ticket, and an application may be offered to the remote node, signed by the node, when the remote node is missing an application/service, resulting in a lack of capability that was queried. The ticket may be valid for a limited period of time, and the node may be authenticated to access the remote node, wherein the authentication is renewed periodically.

A trust level indication and/or processing tags may be added to contents shared between the node and the remote node, and a content with trust level indication and/or processing tags may be received from other nodes of the communication network, and the trust level may be shown, and/or the content may be processed in accordance with the trust level and/or the processing tags.

Moreover, according to a further embodiment of the invention, a method is provided comprising storing rules for accepting packets from addresses of remote nodes to an address of a node of a communication network for providing connectivity between nodes in a firewall which all communication towards the node has to go through, and receiving public keys of the node used for verification of remote host authentication attempts, receiving a ticket from a remote node, performing authentication challenge to the remote node based on the ticket, and if the authentication challenge is successful, setting the firewall rules to accept packets from an address of the remote node to the address of the node. The method may further comprise providing multiple concurrently valid tickets of different categories to nodes of the communication network, a ticket authenticating a remote node to access the node through the firewall, the kind of access depending on a ticket category, and identifying the ticket category and setting the firewall rules in accordance with the identified ticket category.

The invention may also be implemented as computer program product, wherein the computer program product may comprise a computer-readable medium on which software code portions are stored. The computer program product may also include a program which can be directly loadable into an internal memory of a processing device.

It is to be understood that the above description of the embodiments is illustrative of the invention and is not to be construed as limiting the invention. Various modifications and applications may occur to those skilled in the art without departing from the true spirit and scope of the invention as defined by the appended claims.

1. A communication network comprising:
at least one tunneling server comprising,
an access unit for providing access to the communication network, and
an addressing unit for assigning a dynamic address of a first addressing scheme routable in the communication network to a node connecting itself to the tunneling server, the node having a fixed address of a second addressing scheme, and storing at runtime an association between the fixed address of the second addressing scheme and the dynamic address of the first addressing scheme, the communication network being used for providing seamless peer-to-peer connectivity between nodes of different communication network environments, wherein the tunneling server comprises: an interfacing unit for accepting at least two connections with the same fixed address and a selection unit for selecting one of the at least two connections for sending data packets to the fixed address.

2. A tunneling server device comprising:
an access unit for providing access to a communication network; and
an addressing unit for assigning a dynamic address of a first addressing scheme routable in the communication network to a node connecting itself to the tunneling server, the node having a fixed address of a second addressing scheme, and storing at runtime an association between the fixed address of the second addressing scheme and the dynamic address of the first addressing scheme, the tunneling server device being for use in the communication network for providing seamless peer-to-peer connectivity between nodes of different communication network environments, the tunneling server device further comprising:
an interfacing unit for accepting at least two connections with the same fixed address, and
a selection unit for selecting one of the at least two connections for sending data packets to the fixed address.

3. A node for use in a communication network environment, the node comprising:
a connecting unit for connecting the node to a tunneling server of a communication network providing seamless peer-to-peer connectivity between nodes of different communication network environments, the node having a fixed address of a second addressing scheme, thereby getting assigned a dynamic address of a first addressing scheme routable in the communication network, wherein the connecting unit is configured to provide at least two connections to the tunneling server, the node further comprising:
a receiving unit for receiving data packets via one of the at least two connections from the tunneling server.

4. A method comprising:
providing access to a communication network providing seamless peer-to-peer connectivity between nodes of different communication network environments;
assigning a dynamic address of a first addressing scheme routable in the communication network to a node accessing the method, the node having a fixed address of a second addressing scheme; and
storing at runtime an association between the fixed address of the second addressing scheme and the dynamic address of the first addressing scheme, the method further comprising:
accepting at least two accesses with the same fixed address; and
selecting one of the at least two accesses for sending data packets to the fixed address.

5. A method comprising:
connecting a node to a tunneling server of a communication network providing seamless peer-to-peer connectivity between nodes of different communication network environments, the node having a fixed address of a second addressing scheme, thereby getting assigned a dynamic address of a first addressing scheme routable in the communication network, wherein at least two connections to the tunneling server are provided, the method comprising:
receiving data packets via one of the at least two connections from the tunneling server.
